(19) United States
(12) Patent Application Publication
(10) Pub. No.: US 2023/0371084 A1
(43) Pub. Date: Nov. 16, 2023

(54) SYSTEMS, APPARATUSES AND METHODS FOR FLEXIBLE INITIAL ACCESS PROCESSES IN A WIRELESS COMMUNICATION SYSTEM

(71) Applicant: HUAWEI TECHNOLOGIES CO., LTD., SHENZHEN (CN)

(72) Inventors: HAO TANG, Shenzhen (CN); LIQING ZHANG, Kanata (CA); JIANGLEI MA, Kanata (CA)

(73) Assignee: HUAWEI TECHNOLOGIES CO., LTD., SHENZHEN (CN)

(21) Appl. No.: 18/361,886

(22) Filed: Jul. 30, 2023

Related U.S. Application Data
(63) Continuation of application No. PCT/CN2021/074712, filed on Feb. 1, 2021.

(51) Int. Cl. H04W 74/08; H04W 74/00

(52) U.S. Cl. CPC H04W 74/0833; H04W 74/002

(57) ABSTRACT

Systems, apparatuses and methods for providing flexible initial access processes in a wireless communication system are disclosed. These initial access processes may flexibly implement multiple frequency resources and/or multiple beams, which may improve spectrum utilization, improve load balance for a random access channel (RACH), reduce RACH collision and/or improve wireless coverage. According to one example method, an apparatus may receive, on a first downlink carrier and/or bandwidth part (carrier/BWP), a synchronization signal block (SSB) and first information. The first information indicates a plurality of RACH resources corresponding to a plurality of carriers/BWPs and/or to a plurality of beams. The apparatus may also transmit, on a first uplink carrier/BWP, a first message using a first RACH resource of the plurality of RACH resources.

### RELATED APPLICATION

This application is a continuation of International Application No. PCT/CN2021/074712, filed on Feb. 1, 2021, and entitled “SYSTEMS, APPARATUSES AND METHODS FOR FLEXIBLE INITIAL ACCESS PROCESSES IN A WIRELESS COMMUNICATION SYSTEM,” the disclosure of which is hereby incorporated by reference in its entirety.

### FIELD

The present disclosure generally relates to wireless communication and, in particular embodiments, to flexible initial access processes in a wireless communication system.

### BACKGROUND

An air interface is the wireless communications link between two or more communicating devices, such as a base station (also commonly referred to as an evolved NodeB, NodeB, NR base station, a transmit point, a remote radio head, a communications controller, a controller, and the like) and a user equipment (UE) (also commonly referred to as a mobile station, a subscriber, a user, a terminal, a phone, and the like).

A wireless communication from a UE to a base station is referred to as an uplink communication. A wireless communication from a base station to a UE is referred to as a downlink communication. Resources are required to perform uplink and downlink communications. For example, a base station may wirelessly transmit data to a UE in a downlink communication at a particular frequency for a particular duration of time. The frequency and time duration are examples of resources, typically referred to as “time-frequency resources”.

Two devices that wirelessly communicate with each other over time-frequency resources need not necessarily be a UE and a base station. For example, two UEs may wirelessly communicate with each other over a sidelink using device-to-device (D2D) communication. As another example, two network devices (for example, a terrestrial base station and a non-terrestrial base station, such as a drone) may wirelessly communicate with each other over a backhaul link.

A UE may establish communication to a base station through an initial access process. The initial access process may allow the UE and the BS to obtain the necessary information to initiate data exchange. However, the initial access processes currently available have limitations. In some cases, these initial access processes only utilize a limited set of resources, which may potentially result in poor spectrum utilization, load imbalance for physical random access channel (PRACH) transmissions, increased PRACH collisions and/or limited uplink coverage, for example.

### SUMMARY

Some embodiments disclosed herein provide flexible initial access processes. These flexible initial access processes may enable multiple different uplink spectral resources and/or multiple different downlink spectral resources to be utilized for initial access. Further, the uplink spectral resources and the downlink spectral resources may be decoupled, enabling an uplink spectral resource to be selected for initial access independent of a downlink spectral resource. Multiple uplink beams may also or instead be implemented during the flexible initial access processes, which may enable transmit beam sweeping to determine a preferred transmit beam. Compared to conventional initial access processes, the flexible initial access processes disclosed herein may improve spectrum utilization, improve load balance for PRACH transmissions, reduce PRACH collision and/or improve uplink coverage, for example.

According to an aspect of the present disclosure, there is provided a method. The method includes receiving, on a first downlink carrier and/or bandwidth part (carrier/BWP), a synchronization signal block (SSB) and first information. The first information indicates a plurality of random access channel (RACH) resources corresponding to a plurality of carriers/BWPs and/or to a plurality of beams. The method further includes transmitting, on a first uplink carrier/BWP, a first message using a first RACH resource of the plurality of RACH resources. The first downlink carrier/BWP may be in a different frequency band than the first uplink carrier/BWP.

In some embodiments, the plurality of RACH resources corresponds to a plurality of uplink carriers/BWPs for random access. The apparatus may select an uplink carrier/BWP from the plurality of uplink carriers/BWPs to help provide load balance for.

PRACH transmissions and/or to help reduce RACH collisions.

In some embodiments, the plurality of RACH resources corresponds to a plurality of downlink carriers/BWPs for random access. The first RACH resource used to transmit the first message may indicate which downlink carrier/BWP has been selected for initial access. For example, the first RACH resource may include at least one of a time resource, a frequency resource, a RACH preamble or a RACH format that is indicative of the apparatus monitoring the second downlink carrier/BWP for a second message. This may reduce synchronization overhead in the network. For example, an SSB might not be sent on the second downlink carrier/BWP, yet the second downlink carrier/BWP may still be accessed by the apparatus for initial access.

In some embodiments, transmit beam sweeping may be performed by the apparatus to determine a preferred transmit beam. For example, the plurality of RACH resources may correspond to a plurality of transmit beams. The method may further include transmitting, on at least some of the plurality of transmit beams, a plurality of messages using the plurality of RACH resources. Transmitting the plurality of messages may include transmitting the first message on a first transmit beam. The method may then include determining, based on a second message received by the apparatus, that the first transmit beam is a preferred transmit beam of the plurality of transmit beams. For example, at least a portion of the second message may scrambled using a first identifier corresponding to the first RACH resource, which indicates that the first transmit beam is the preferred transmit beam. Determining a preferred transmit beam during an initial access process may improve initial access successful rate and/or reduce the latency of initial access.

According to another aspect of the present disclosure, there is provided a method. The method includes transmitting, on a first downlink carrier/BWP, an SSB and first information, the first information indicating a plurality of RACH resources corresponding to a plurality of carriers/BWPs and/or to a plurality of beams. The method also includes receiving, from an apparatus on a first uplink carrier/BWP, a first message using a first RACH resource of the plurality of RACH resources.

In some embodiments, when the plurality of RACH resources corresponds to a plurality of uplink carriers/BWPs for random access, the method may further include determining that the apparatus received the SSB on the first downlink carrier/BWP based on at least one of a time resource, a frequency resource, a RACH preamble or a RACH format of the first RACH resource.

According to a further aspect of the present disclosure, there is provided an apparatus including at least one processor and a computer readable storage medium operatively coupled to the at least one processor, the computer readable storage medium storing programming for execution by the at least one processor. The programming includes instructions to receive, on a first downlink carrier/BWP, an SSB and first information, the first information indicating a plurality of RACH resources corresponding to a plurality of carriers/BWPs and/or to a plurality of beams. The programming also includes instructions to transmit, on a first uplink carrier/BWP, a first message using a first RACH resource of the plurality of RACH resources.

According to yet another aspect of the present disclosure, there is provided a system including at least one processor and at least one computer readable storage medium operatively coupled to the at least one processor, the at least one computer readable storage medium storing programming for execution by the at least one processor. The programming includes instructions to transmit, on a first downlink carrier/BWP, an SSB and first information, the first information indicating a plurality of RACH resources corresponding to a plurality of carriers/BWPs and/or to a plurality of beams. The programming also includes instructions to receive, from an apparatus on a first uplink carrier/BWP, a first message using a first RACH resource of the plurality of RACH resources.

### BRIEF DESCRIPTION OF THE DRAWINGS

Reference will now be made, by way of example, to the accompanying drawings which show example embodiments of the present application, and in which:

FIG. 1 is a schematic diagram of an example communication system suitable for implementing examples described herein;

FIG. 2 is a schematic diagram of another example communication system suitable for implementing examples described herein;

FIG. 3 is a block diagram illustrating example devices that may implement the methods and teachings according to this disclosure;

FIG. 4 is a block diagram illustrating example computing modules that may implement the methods and teachings according to this disclosure;

FIG. 5 illustrates four carriers on a frequency spectrum of a wireless medium;

FIG. 6 illustrates a single carrier having a single bandwidth part (BWP) consisting of two non-contiguous spectrum resources;

FIG. 7 illustrates a BWP on a frequency spectrum of a wireless medium;

FIG. 8 illustrates a single BWP having four non-contiguous spectrum resources;

FIG. 9 illustrates multiple candidate DL carriers and multiple candidate UL carriers that are configured for use in an initial access process, according to an embodiment;

FIG. 10 is a signaling diagram illustrating a contention-based initial access process that flexibility implements spectral resources, according to an embodiment;

FIG. 11 is a block diagram illustrating a base station transmitting synchronization signal blocks (SSBs) and system information blocks (SIBs) to a UE on different downlink carriers, according to an embodiment;

FIG. 12 is a block diagram illustrating an example resource configuration for the downlink carriers of FIG. 11;

FIG. 13 is a diagram illustrating two time-frequency plots that each include two RACH references of FIG. 12;

FIG. 14 is a diagram illustrating priority indications for uplink carriers of FIGS. 11 and 12;

FIG. 15 is a block diagram illustrating a super wideband carrier, according to an embodiment;

FIG. 16 is a time-frequency plot illustrating multiple RACH resources corresponding to downlink carriers and/or bandwidth parts (BWPs) of the super wideband carrier of FIG. 15;

FIG. 17 is a diagram illustrating a UE communicating with two transmission and reception points (TRPs) via respective beams, according to an embodiment;

FIG. 18 is a block diagram illustrating a transmit beam sweeping operation during a contention-based initial access process, according to an embodiment;

FIG. 19 is a flow diagram illustrating a method for implementing transmit beam sweeping during a contention-based initial access process, according to an embodiment;

FIG. 20 is a time-frequency plot including multiple RACH resources for transmit beam sweeping, according to an embodiment; and

FIGS. 21 and 22 are flow diagrams illustrating methods according to embodiments.

### DESCRIPTION OF EXAMPLE EMBODIMENTS

To assist in understanding the present disclosure, examples of a wireless communication system are described below.

### Example Communication Systems and Devices

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

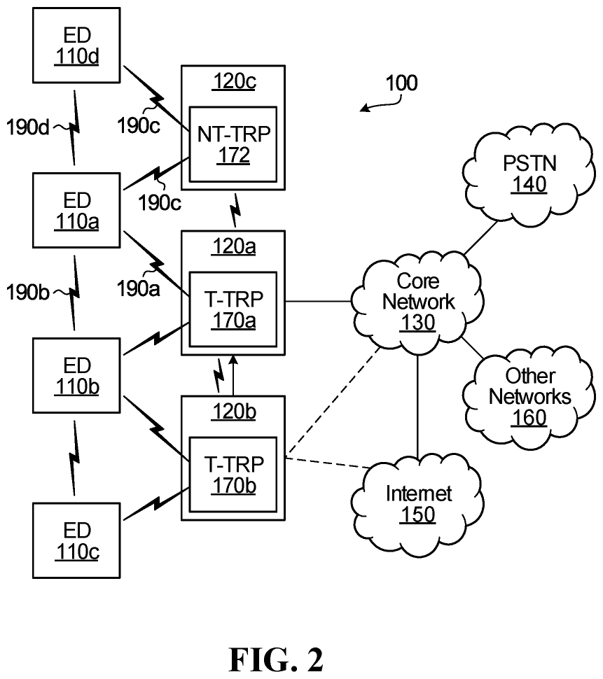

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. In some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

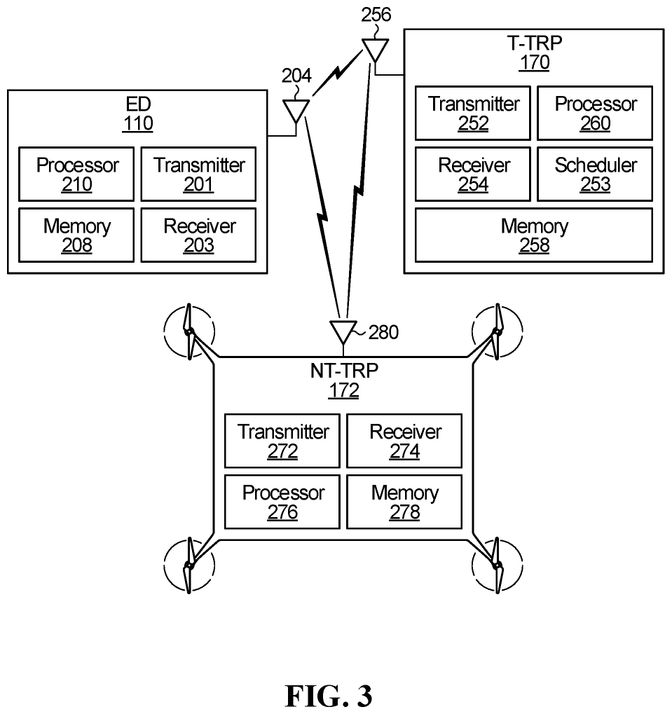

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

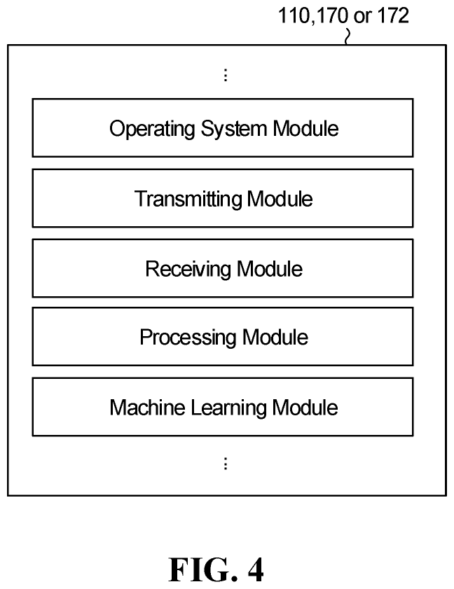

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

### Cells, Carriers, Bandwidth Parts (BWPs) and Occupied Bandwidth

A device, such as a base station, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g. the center or lowest or highest frequency of the carrier. A carrier may be on licensed or unlicensed spectrum. Wireless communication with the device may also or instead occur over one or more BWPs. For example, a carrier may have one or more BWPs. More generally, wireless communication with the device may occur over a wireless spectrum. The spectrum may comprise one or more carriers and/or one or more BWPs. The spectrum may be referred to as frequency resources. Different carriers and/or BWPs may be on distinct frequency resources.

A cell may include one or multiple downlink resources and optionally one or multiple uplink resources, or a cell may include one or multiple uplink resources and optionally one or multiple downlink resources, or a cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may instead or additionally include one or multiple sidelink resources, e.g. sidelink transmitting and receiving resources.

A BWP may be broadly defined as a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

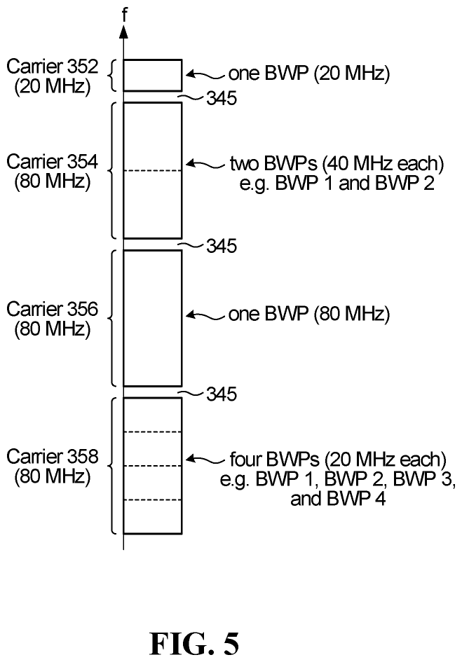

Therefore, in some embodiments, a carrier may have one or more BWPs. As an example, FIG. 5 illustrates four carriers on a frequency spectrum of a wireless medium. The four carriers are respectively labelled carriers 352, 354, 356, and 358. The four carriers are contiguous with each other, except that a guard band 345 may be interposed between adjacent pairs of contiguous carriers. Carrier 352 has a bandwidth of 20 MHz and consists of one BWP. Carrier 354 has a bandwidth of 80 MHz and consists of two adjacent contiguous BWPs, each BWP being 40 MHz, and respectively identified as BWP 1 and BWP 2. Carrier 356 has a bandwidth of 80 MHz and consists of one BWP. Carrier 358 has a bandwidth of 80 MHz and consists of four adjacent contiguous BWPs, each BWP being 20 MHz, and respectively identified as BWP 1, BWP 2, BWP 3, and BWP 4. Although not shown, a guard band may be interposed between adjacent BWPs.

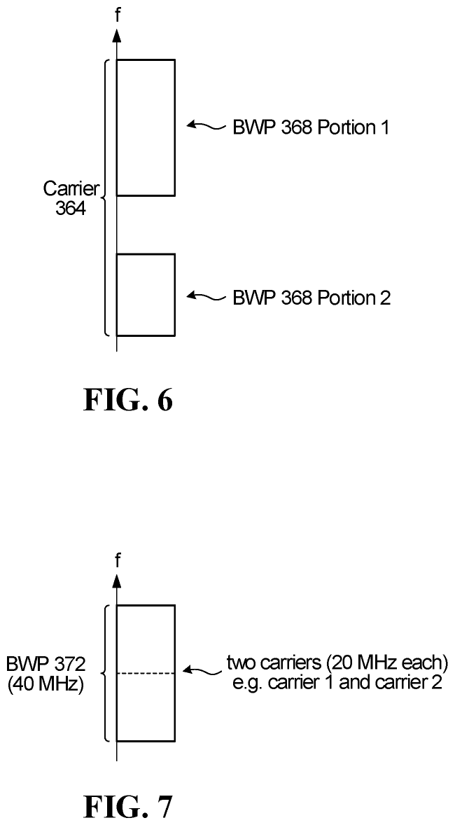

In some embodiments, a BWP has non-contiguous spectrum resources on one carrier. For example, FIG. 6 illustrates a single carrier 364 having a single BWP 368 consisting of two non-contiguous spectrum resources: BWP portion 1 and BWP portion 2.

In other embodiments, rather than a carrier having one or more BWPs, a BWP may have one or more carriers. For example, FIG. 7 illustrates a BWP 372 on a frequency spectrum of a wireless medium. BWP 372 has a bandwidth of 40 MHz and consists of two adjacent carriers, labelled carrier 1 and carrier 2, with each carrier having a bandwidth of 20 MHz. Carriers 1 and 2 are contiguous, except that a guard band (not shown) may be interposed between the carriers.

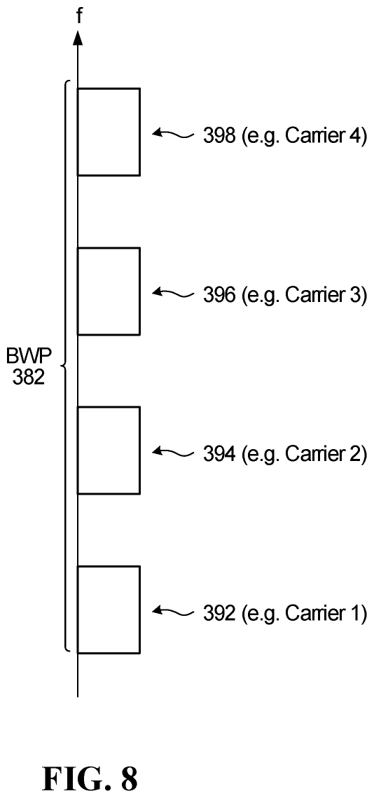

In some embodiments, a BWP may comprise non-contiguous spectrum resources which consists of non-contiguous multiple carriers. For example, FIG. 8 illustrates a single BWP 382 having four non-contiguous spectrum resources 392, 394, 396, and 398. Each non-contiguous spectrum resource consists of a single carrier. The first spectrum resource 392 is in a low band (e.g. the 2 GHz band) and consists of a first carrier (carrier 1). The second spectrum resource 394 is in a mmW band and consists of a second carrier (carrier 2). The third spectrum resource 396 (if it exists) is in the THz band and consists of a third carrier (carrier 3). The fourth spectrum resource 398 (if it exists) is in visible light band and consists of a fourth carrier (carrier 4). Resources in one carrier which belong to the BWP may be contiguous or non-contiguous. For example, the frequency resources of carrier 1 might be contiguous or non-contiguous.

Therefore, in view of the examples described in relation to FIGS. 5 to 8, it will be appreciated that a carrier may be a contiguous spectrum block for transmission and/or reception by device, such as a base station or a UE (e.g. like in FIG. 5), or a non-contiguous spectrum block for transmission and/or reception by a device (e.g. like in FIG. 6). A BWP may be a contiguous spectrum block for transmission and/or reception (e.g. like in FIGS. 5 and 7), or a contiguous spectrum block within a carrier (e.g. like in FIG. 5), or a non-contiguous spectrum block (e.g. like in FIGS. 6 and 8). A carrier may have one or more BWPs, or a BWP may have one or more carriers. A carrier or BWP may alternatively be referred to as spectrum.

As used herein, “carrier/BWP” refers to a carrier, or a BWP or both. For example, the sentence “the UE 110 sends a transmission on an uplink carrier/BWP” means that the UE 110 may send the transmission on an uplink carrier (that might or might not have one or more BWPs), or the UE may send the transmission on an uplink BWP (that might or might not have one or more carriers). The transmission might only be on a carrier, or might only be on a BWP, or might be on both a carrier and a BWP (e.g. on a BWP within a carrier).

Wireless communication may occur over an occupied bandwidth. The occupied bandwidth may be defined as the width of a frequency band such that, below the lower and above the upper frequency limits, the mean powers emitted are each equal to a specified percentage β/2 of the total mean transmitted power, for example, the value of β/2 is taken as 0.5%.

In some embodiments, a carrier, a BWP and/or an occupied bandwidth may be signaled by a network device (e.g. a base station) dynamically (e.g. in physical layer control signaling such as downlink control information (DCI)), semi-statically (e.g. in radio resource control (RRC) signaling or in the medium access control (MAC) layer), or be predefined based on the application scenario. Alternatively or additionally, a carrier, a BWP and/or an occupied bandwidth may be determined by a UE as a function of other parameters that are known by the UE, or may be fixed, e.g. by a standard.

In some embodiments herein, a carrier/BWP is sometimes configured as an “uplink carrier/BWP” or a “downlink carrier/BWP”. An uplink carrier/BWP is a carrier or BWP that is configured for uplink transmission. A downlink carrier/BWP is a carrier or BWP that is configured for downlink transmission.

Control information is discussed herein in some embodiments. Control information may sometimes instead be referred to as control signaling, signaling, configuration information, or a configuration. An example of control information is information configuring different carriers/BWPs. In some cases, control information may be dynamically indicated to the UE, e.g. in the physical layer in a control channel. An example of control information that is dynamically indicated is information sent in physical layer control signaling, e.g. downlink control information (DCI). Control information may sometimes be semi-statically indicated, e.g. in RRC signaling or in a MAC control element (MAC CE). A dynamic indication may be an indication in a lower layer (e.g. physical layer or layer 1 signaling such as DCI), rather than in a higher-layer (e.g. rather than in RRC signaling or in a MAC CE). A semi-static indication may be an indication in semi-static signaling. Semi-static signaling, as used herein, may refer to signaling that is not dynamic, e.g. higher-layer signaling, RRC signaling, and/or a MAC CE. Dynamic signaling, as used herein, may refer to signaling that is dynamic, e.g. physical layer control signaling sent in the physical layer, such as DCI.

It should be noted that while some embodiments of the present disclosure are described in relation to communications between a UE and a BS (for example, uplink and/or downlink transmissions), the present disclosure is in no way limited to these communications. The embodiments described herein may also or instead be implemented in sidelink, backhaul links and/or vehicle-to-everything (V2X) links, for example. Further, the embodiments described herein may apply to transmissions over licensed spectrum, unlicensed spectrum, terrestrial transmissions, non-terrestrial transmissions (for example, transmissions within non-terrestrial networks), and/or integrated terrestrial and non-terrestrial transmissions.

### Integrated Terrestrial Networks and Non-Terrestrial Networks

A terrestrial communication system may also be referred to as a land-based or ground-based communication system, although a terrestrial communication system can also, or instead, be implemented on or in water. The non-terrestrial communication system may bridge the coverage gaps for underserved areas by extending the coverage of cellular networks through non-terrestrial nodes, which will be key to ensuring global seamless coverage and providing mobile broadband services to unserved/underserved regions, in this case, it is hardly possible to implement terrestrial access-points/base-stations infrastructure in the areas like oceans, mountains, forests, or other remote areas.

The terrestrial communication system may be a wireless communication system using 5G technology and/or later generation wireless technology (e.g., 6G or later). In some examples, the terrestrial communication system may also accommodate some legacy wireless technology (e.g., 3G or 4G wireless technology). The non-terrestrial communication system may be a communications using the satellite constellations like conventional Geo-Stationary Orbit (GEO) satellites which utilizing broadcast public/popular contents to a local server, Low earth orbit (LEO) satellites establishing a better balance between large coverage area and propagation path-loss/delay, stabilize satellites in very low earth orbits (VLEO) enabling technologies substantially reducing the costs for launching satellites to lower orbits, high altitude platforms (HAPs) providing a low path-loss air interface for the users with limited power budget, or Unmanned Aerial Vehicles (UAVs) (or unmanned aerial system (UAS)) achieving a dense deployment since their coverage can be limited to a local area, such as airborne, balloon, quadcopter, drones, etc. In some examples, GEO satellites, LEO satellites, UAVs, HAPs and VLEOs may be horizontal and two-dimensional. In some examples, UAVs, HAPs and VLEOs coupled to integrate satellite communications to cellular networks emerging 3D vertical networks consist of many moving (other than geostationary satellites) and high altitude access points such as UAVs, HAPs and VLEOs.

### Artificial Intelligence (AI) and Sensing

In some embodiments, devices such as the ED 110, the T-TRP 170 and/or the NT-TRP 172 of FIG. 3 implement sensing technologies and/or AI technologies. Sensing and/or AI may be introduced into a telecommunication system to improve performance and efficiency.

AI and/or machine learning (ML) technologies may be applied in the physical layer and/or in the MAC layer. For the physical layer, AI/ML may improve component design and/or algorithm performance, including but not limited to channel coding, channel modelling, channel estimation, channel decoding, modulation, demodulation, MIMO, waveform, multiple access, PHY element parameter optimization and update, beam forming & tracking, and sensing & positioning. For the MAC layer, AI/ML capabilities such as learning, prediction and decision making, for example, may be utilized to solve complicated problems. According to an example, AI/ML may be utilized to improve functionality in the MAC layer through intelligent TRP management, intelligent beam management, intelligent channel resource allocation, intelligent power control, intelligent spectrum utilization, intelligent MCS, intelligent HARQ strategy, and/or intelligent Tx/Rx mode adaption.

In some embodiments, AI/ML architectures involve multiple nodes. The multiple nodes may be organized into two modes, i.e., centralized and distributed, both of which can be deployed in an access network, a core network, or an edge computing system or third network. The implementation of a centralized training and computing architecture may be restricted by a large communication overhead and strict user data privacy. A distributed training and computing architecture, such as distributed machine learning and federated learning, for example, may include several frameworks. AI/ML architectures could include an intelligent controller which may perform as single agent or multi-agent, based on joint optimization or individual optimization. A protocol and signaling mechanism may provide a corresponding interface link that can be personalized with customized parameters to meet particular requirements while minimizing signaling overhead and maximizing the whole system spectrum efficiency through personalized AI technologies.

Through the use of sensing technologies, terrestrial and non-terrestrial networks can enable a new range of services and applications such as earth monitoring, remote sensing, passive sensing and positioning, navigation, tracking, autonomous delivery and mobility. Terrestrial network-based sensing and non-terrestrial network-based sensing could provide intelligent, context-aware networks to enhance the UE experience. For an example, terrestrial network-based sensing and non-terrestrial network-based sensing could provide opportunities for localization and sensing applications based on a new set of features and service capabilities. Applications such as THz imaging and spectroscopy have the potential to provide continuous, real-time physiological information via dynamic, non-invasive, contactless measurements for future digital health technologies. Simultaneous localization and mapping (SLAM) methods might not only enable advanced cross reality (XR) applications, but also enhance the navigation of autonomous objects such as vehicles and drones. Further, measured channel data and sensing and positioning data can be obtained through large bandwidth, new spectrum, dense networks and more line-of-sight (LOS) links. Based on measured channel data and sensing and positioning data, a radio environmental map may be drawn through AI/ML methods, where channel information is linked to its corresponding positioning or environmental information to provide an enhanced physical layer design based on this map.

Sensing coordinators are nodes in a network that can assist in the sensing operation. These nodes can be stand-alone nodes dedicated to sensing operations or other nodes (for example the T-TRP 170, ED 110, or core network node) that perform sensing operations in parallel with communication transmissions. Protocol and signaling mechanisms may provide a corresponding interface link with customized parameters to meet particular requirements while minimizing signaling overhead and maximizing spectrum efficiency.

AI/ML and sensing methods may be data-hungry. Therefore, in order to involve AI/ML and sensing in wireless communications, a large amount of data may be collected, stored, and exchanged. The characteristics of wireless data may expand in multiple dimensions, such as from sub-6 GHz, millimeter to Terahertz carrier frequencies, from outdoor to indoor environments, and from text, voice to video. The data collecting, processing and usage may be performed in a unified framework or another framework.

### Beams and Beamforming

Some embodiments of the present disclosure relate to beams and beamforming in a wireless communication system. A beam may be formed through amplitude and/or phase weighting on data transmitted or received by at least one antenna. Alternatively or additionally, a beam may be formed by using another method, for example, adjusting a related parameter of an antenna unit. A beam may include a transmit (Tx) beam and/or a receive (Rx) beam. A Tx beam indicates a distribution of signal strength formed in different directions in space after a signal is transmitted through an antenna. An Rx beam indicates a distribution of signal strength of a wireless signal received by an antenna that is in different directions in space. From the perspective of a UE, a Tx beam may be an UL beam and a Rx beam may be a DL beam. Beam information for a beam may include a beam identifier, an antenna port identifier, a channel state information reference signal (CSI-RS) resource identifier, a synchronization signal block (SSB) resource identifier, a sounding reference signal (SRS) resource identifier and/or another reference signal resource identifier. Beam information for a beam may also or instead include precoding information for the beam, which may provide antenna phase and/or gain weightings to transmit and/or receive on the beam.

A UE and/or a BS may support multiple antenna panels (which are also referred to as “panels”) for transmitting and/or receiving data using multiple different beams. Each panel may operate as (or provide the functionality of) a unit of antenna group, an antenna array or an antenna sub-array. A particular panel at a UE or a BS can support a transmit and/or receive (Tx/Rx) beam independently of the other panels in the device. As such, multiple panels at a UE or BS may support multiple beams simultaneously, which may increase the rate of data transmission for the UE or the BS.

### Initial Access Processes

A UE may establish communication to a BS through an initial access process, which may also be referred to as a “random access process” or a “random access channel (RACH) process”. An initial access process may allow a UE to perform uplink and/or downlink synchronization with a BS, to obtain a UE-specific identifier, to determine an uplink and/or downlink beam between the UE and the BS, to obtain a timing advance (TA) value and/or to establish an RRC connection to the BS.

An initial access process may be contention-based or contention-free. In some embodiments, a contention-based initial access process includes four steps referred to as “step 1”, “step 2”, “step 3” and “step 4”, as well as a preliminary step referred to as “step 0”. In step 0, a UE may receive one or more synchronization signals from a BS. An example of such synchronization signals is a synchronization signal block (SSB). The UE may also receive system information from the BS in step 0. This system information may include minimum system information (MSI), a master information block (MIB) and/or a system information block (SIB). The system information may provide the UE with RACH configuration information for random access, which may include a pool RACH resources and a corresponding pool of RACH preambles. A RACH resource, which may also be referred to as a “RACH occasion”, may include time-frequency resources for transmitting a corresponding RACH preamble to the BS. The RACH preamble provides a signature that may help the BS identify the UE during the initial access process.

In step 1 of the contention-based initial access process, the UE selects a RACH resource from the pool of RACH resources and transmits a corresponding RACH preamble to the BS using the selected RACH resource. The transmission of the RACH preamble may be referred to as a “physical RACH (PRACH)” transmission or a “Msg1” transmission. In some cases, the selection of the RACH resource by the UE may be at least partially random, which could result in collision and/or contention if another UE also randomly selects the same RACH resource. This contention may be resolved in step 4.

In step 2 of the contention-based initial access process, the BS sends a random access response (RAR) to the UE that is scheduled by the physical downlink control channel (PDCCH). The RAR may be referred to as “Msg2”. The RAR may schedule a physical uplink shared channel (PUSCH) transmission from the UE. In step 3, the UE transmits the scheduled PUSCH transmission, which may be referred to as a “Msg3” transmission. The PUSCH transmission may include an identifier for the UE that could be used for contention resolution. In step 4, the base station may send the UE a message on the PDCCH, which may be referred to as “Msg4”, to perform contention resolution.

Contention-free initial access processes may reduce or remove the possibility of contention by assigning a specific RACH resource and/or a specific RACH preamble to a UE. A contention-free initial access process may be performed in the case of a handover from one BS to another BS and/or in the case of a burst of downlink data being scheduled for a UE, for example. In some embodiments, a contention-free initial access process includes two steps referred to as “step 1” and “step 2”. In a preliminary step of the contention-free initial access process, referred to as “step 0”, a UE may receive a RACH resource and/or a RACH preamble assignment from a BS. The RACH resource and/or RACH preamble may be specifically assigned to the UE, and therefore contention between the UE and other UEs may be avoided. In step 1 of the contention-free initial access process, the UE transmits the assigned RACH preamble to the BS using the RACH resource. In step 2, the BS transmits an RAR to the UE.

### Flexible Initial Access Processes Using Multiple Spectral Resources

Some conventional initial access processes may limit or otherwise restrict the uplink (UL) and downlink (DL) spectral resources that may be used for transmitting initial access messages. For example, when a UE is synchronized to one DL carrier and receives system information from the DL carrier, only one or two UL carriers may be configured for transmissions between the UE and a BS during a conventional initial access process. The UE and the BS may be limited to the use of the DL carrier and the one or two UL carriers, which may decrease the flexibility and efficiency of the initial access process. For example, if the UE and the BS support more than two UL carriers, then restricting the initial access process to one or two UL carriers may result in poor spectrum utilization, load imbalance for RACH, increased RACH collisions and/or limited UL coverage. Similar comments may also apply to restricting the initial access process to a single DL carrier when the UE and the BS support multiple DL carriers.

By way of example, in step 0 of a conventional, contention-based initial access process, an SIB received by a UE on a DL carrier may indicate that a single UL carrier is configured for PRACH transmissions. In this way, the DL and UL spectrum for the initial access process may be coupled. If the DL carrier is in an FDD spectrum band, then the UL carrier may be in the paired UL spectrum of the FDD band. Alternatively, if the DL carrier is in a TDD spectrum band, then the UL carrier may be in the same TDD band. Further, if the DL carrier is in a band combination for LTE-NR coexistence with UL sharing, then the UL carrier may be a supplemental UL (SUL) carrier. This ultimately limits the number of UL carriers and the spectrum locations of UL carriers that may be used for initial access, potentially leading to decreased flexibility and efficiency for the initial access process.

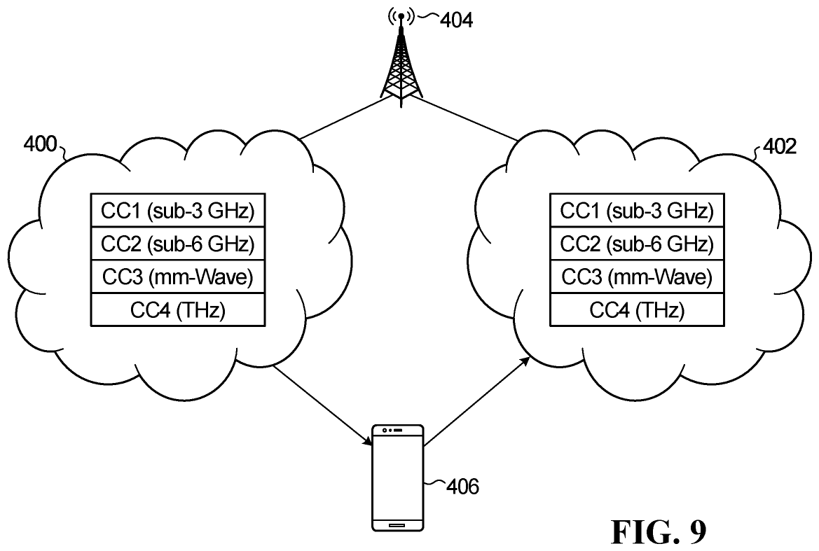

An aspect of the present disclosure relates to the flexible use of UL and/or DL spectral resources during initial access processes. The flexible use of UL and/or DL spectral resources may include, but is not limited to, enabling a UE and/or a BS to select an UL carrier and/or a DL carrier from a set of multiple candidate carriers that are configured for initial access. FIG. 9 illustrates multiple candidate DL carriers 400 and multiple candidate UL carriers 402 that are configured for use in an initial access process, according to an embodiment. The candidate DL carriers 400 and the candidate UL carriers 402 each include CC1, CC2, CC3 and CC4. CC1 occupies the sub-3 GHz frequency spectrum, CC2 occupies the frequency spectrum between 3 GHz and 6 GHz, CC3 occupies the mm-Wave frequency spectrum and CC4 occupies the THz frequency spectrum. The candidate DL carriers 400 may be in an FDD band, a TDD band, a supplemental DL (SDL) band, an unlicensed band and/or full duplex band, for example. Similarly, the candidate UL carriers 402 may be in an FDD band, a TDD band, a SUL band, an unlicensed band and/or full duplex band.

The candidate DL carriers 400 and the candidate UL carriers 402 may be used in an initial access process involving a BS 404 and a UE 406. In some implementations, the BS 404 is similar to the T-TRP 170 or to the NT-TRP 172 of FIGS. 1 to 3, and/or the UE 406 is similar to the ED 110 of FIGS. 1 to 3. The BS 404 and/or the UE 406 may select a DL carrier for initial access from the candidate DL carriers 400 and select a UL carrier for initial access from the candidate UL carriers 402. The selected DL carrier and UL carrier may be decoupled. For example, the UL carrier may be selected from the candidate UL carriers 402 independent of the DL carrier that is selected from the candidate DL carriers 400. This may allow the BS 404 and/or the UE 406 to flexibly select the DL carrier and/or the UL carrier for initial access to improve spectrum utilization, improve load balance for RACH, reduce RACH collision and/or improve UL/DL coverage, for example.

It should be noted that the embodiments provided herein are not limited to initial access processes using multiple candidate UL and/or DL carriers (or CCs). The flexible use of UL and/or DL spectral resources may also include flexibility selecting other types of spectral resources for initial access. In some embodiments, a UE and/or a BS selects an UL BWP and/or a DL BWP from a set of multiple candidate BWPs that are configured for initial access. For example, the candidate DL carriers 400 may instead be candidate DL BWPs that are configured for initial access, including BWP1 occupying the sub-3 GHz frequency spectrum, BWP2 occupying the frequency spectrum between 3 GHz and 6 GHz, BWP3 occupying the mm-Wave frequency spectrum and BWP4 occupying the THz frequency spectrum. Further, the candidate UL carriers 402 may instead be candidate UL BWPs configured for initial access. The BS 404 and/or the UE 406 may select a DL BWP and an UL BWP for initial access from the candidate DL and UL BWPs.

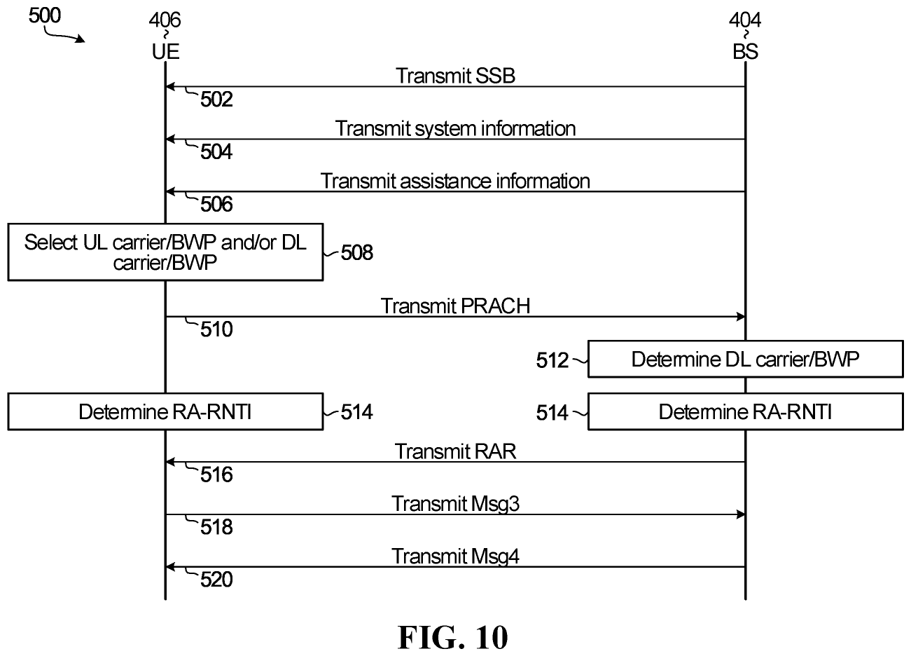

FIG. 10 is a signaling diagram illustrating a contention-based initial access process 500 that flexibility implements spectral resources, according to an embodiment. The process 500 generally involves the UE 406 establishing communication to the BS 404 of FIG. 9.

In step 502, the BS 404 transmits one or more SSBs, and at least one of the SSBs is received by the UE 406. The UE 406 may use the received SSB to perform DL synchronization and/or to determine a DL beam between the UE 406 and the BS 404. Further, the UE 406 may decode the physical broadcast channel (PBCH) included in the received SSB to obtain an MIB. In step 504, the BS 404 transmits system information to the UE 406. This system information may include remaining minimum system information (RMSI), including an SIB. The system information may be transmitted via the PDSCH in step 504. The system information may provide the UE 406 with RACH configuration information, including a pool of RACH resources and a corresponding pool of RACH preambles. Further details regarding the SSBs and the system information transmitted in steps 502, 504 are provided elsewhere herein. Steps 502, 504 may be considered an example implementation of step 0 of a contention-based initial access process.

In some implementations, steps 502, 504 utilize multiple DL carriers/BWPs. For example, the BS 404 may transmit the SSBs and/or the system information on multiple DL carriers/BWPs. The candidate DL carriers 400 of FIG. 9 are examples of DL carriers/BWPs that may be used to transmit the SSBs and the system information. The UE 406 may receive an SSB and/or system information on more than one DL carrier/BWP, which may allow the UE 406 to select a DL carrier/BWP for use in initial access.

Steps 502, 504 may also or instead involve multiple UL carriers/BWPs. For example, the system information received by the UE 406 in step 504 may indicate that multiple candidate UL carriers/BWPs are configured for initial access. The RACH resources indicated in the system information may include resources on each of the candidate UL carriers/BWPs, and therefore any of the candidate UL carriers/BWPs may be used for PRACH transmissions. The candidate UL carriers 402 of FIG. 9 are examples of UL carriers/BWPs that may be indicated in the system information received in step 504.

Step 506 includes the BS 404 transmitting assistance information to the UE 406. When multiple candidate UL carriers/BWPs are configured for initial access, the assistance information may help the UE 406 select an UL carrier/BWP for use in the process 500. In some implementations, the assistance information may include at least one of a traffic load, an interference degree, a RACH collision ratio, a successful RACH ratio, a priority indication or a coverage range for one or more of the candidate UL carriers/BWPs.

The traffic load for an UL carrier/BWP may provide an indication of how heavily used the UL carrier/BWP is in the network. An UL carrier/BWP with a high traffic load may be undesirable for use in the process 500.

An interference degree for a carrier/BWP is a measure of the interference on the carrier/BWP. The interference degree may be characterized as low, medium or high. A high interference degree is one in which the interference on the carrier/BWP approaches or exceeds the signal power. In other words, a high interference degree may correspond to an interference to signal ratio (ISR) that is greater than or equal to 1. An UL carrier/BWP with a high interference degree may be undesirable for use in the process 500.

A RACH collision ratio represents the probability of RACH collision or contention at a certain time. The RACH collision ratio may be calculated based on the number of RACH collisions divided by the number of RACH processes over a time period. An UL carrier/BWP with a high RACH collision ratio may be undesirable for use in the process 500.

A successful RACH ratio represents the probability of a successful PRACH transmission without contention at a certain time. An UL carrier/BWP with a high successful RACH ratio may be desirable for use in the process 500.

The coverage range for a UL carrier/BWP represents the coverage distance between a BS and a UE on the UL carrier/BWP. The coverage range may relate to the allowed pathloss on the UL carrier/BWP. An UL carrier/BWP with a higher coverage range may be desirable for use in the process 500.

The priority indication for an UL carrier/BWP may provide a metric for the availability of the UL carrier/BWP for initial access. In some implementations, a priority indication for an UL carrier/BWP may be based on the traffic load, interference degree, RACH collision ratio and/or successful RACH ratio for the UL carrier/BWP. Further details regarding assistance information that may be transmitted in step 506 are provided elsewhere herein.

In some implementations, the assistance information may be transmitted with the system information in step 504. Therefore, steps 504, 506 may be performed as a single step.

Step 508 includes the UE 406 selecting an UL carrier/BWP and/or a DL carrier/BWP from the multiple candidate UL carriers/BWPs and/or DL carriers/BWPs that are configured for initial access. In some implementations, multiple SSBs are received on different SSB resources in step 502. The different SSB resources may correspond to different DL carriers/BWPs, and a particular DL carrier/BWP may be selected in step 508 based on the best received SSB. For example, if the reference signal received power (RSRP) for an SSB received on a first DL carrier/BWP is higher than the RSRP for an SSB received on a second DL carrier/BWP, then the UE 406 may select the first DL carrier/BWP for initial access. In another example, if the reference signal received quality (RSRQ) for an SSB received on the first DL carrier/BWP is higher than the RSRQ for an SSB received on a second DL carrier/BWP, then the UE 406 may select the first DL carrier/BWP for initial access.

In some implementations, the UE 406 uses the assistance information received in step 506 to help select an UL carrier/BWP. The UE 406 may use the assistance information to determine the candidate UL carriers/BWPs that are relatively under-utilized in the network. For example, the UL carriers/BWPs with lower traffic loads, lower interferences degrees, better RACH collision ratios and/or higher successful RACH ratios may be selected in step 508 to improve the performance of UL transmissions in the process 500.

In some implementations, the BS 404 may indicate one or more UL carriers/BWPs of the candidate UL carriers/BWPs that are available for use in an initial access process at any given time. These available UL carriers/BWPs may be the UL carriers/BWPs that the UE 406 is allowed to select in step 508. The selection may be further based on assistance information. If only one UL carrier/BWP is indicated as being available, then the UE 406 may select this UL carrier/BWP in step 508.

The available UL carriers/BWPs could be indicated to the UE 406 in any of a number of different ways. For example, the system information received by the UE 406 in step 504 may indicate multiple candidate UL carriers/BWPs that are configured for initial access, and also indicate one or more available UL carriers/BWPs within the candidate UL carriers/BWPs. By way of example, for each candidate UL carrier/BWP, the system information may include a bit to indicate whether the UL carrier/BWP is available. The available UL carriers/BWPs may form a proper subset of the candidate UL carriers/BWPs, such that the number of available UL carriers/BWPs is less than the number of candidate UL carriers/BWPs. The assistance information received by the UE 406 in step 506 may also or instead indicate one or more available UL carriers/BWPs within the candidate UL carriers/BWPs

Indicating the available UL carriers/BWPs may allow the BS 404 to at least partially manage the UL carriers/BWPs used in the process 500, which may help ensure a relatively even distribution of traffic load across the candidate UL carriers/BWPs. The BS 404 may determine which of the candidate UL carriers/BWPs are available in any of a number of different ways. For example, if the BS 404 observes a heavy RACH load on an UL carrier/BWP, then the BS 404 may indicate that the UL carrier/BWP is not available for initial access. In some implementations, the BS 404 may indicate that only the UL carrier/BWP with the lowest RACH load is available for initial access.

Selecting an UL carrier/BWP based on assistance information and/or based on an indication of available UL carriers/BWPs in step 508 may allow the UE 406 to avoid randomly selecting an UL carrier/BWP. Random selection of an UL carrier/BWP may have potential disadvantages. For example, random selection of an UL carrier/BWP might not result in the UE 406 using the best performing UL carrier/BWP for initial access, which could reduce the efficiency of the process 500. Further, random selection of an UL carrier/BWP may lead to load imbalance in the candidate UL carriers/BWPs if too many UEs randomly select one UL carrier/BWP over other candidate UL carriers/BWPs.

Step 510 includes the UE 406 transmitting a PRACH to the BS 404 using one of the RACH resources indicated in the system information received in step 504. The PRACH may include a RACH preamble corresponding to the RACH resource. Optionally, the PRACH is transmitted on the UL carrier/BWP selected in step 508. For example, the selected RACH resource may utilize the UL carrier/BWP selected in step 508. Step 510 is an example implementation of step 1 of a contention-based initial access process.

Step 512 includes the BS 404 determining the DL carrier/BWP that the UE 406 is monitoring for an RAR. For example, if multiple candidate DL carriers/BWPs are configured for initial access, then the BS 404 might not implicitly know which DL carrier/BWP the UE 406 has selected for initial access and is monitoring for an RAR. Therefore, the BS 404 may perform step 512 to determine the DL carrier/BWP that the UE 406 is monitoring. As discussed in further detail elsewhere herein, different RACH resources and/or RACH preambles may correspond to the different candidate DL carrier/BWPs. Therefore, the RACH resource and/or the RACH preamble used for the PRACH transmission in step 510 may indicate the DL carrier/BWP that the UE 406 is monitoring.

In some implementations, the DL carrier/BWP monitored by the UE 406 may correspond to an SSB that the UE 406 received in step 502. For example, the UE 406 may monitor the same DL carrier/BWP that the UE 406 received the SSB on. If the UE received multiple SSBs on different DL carriers/BWPs in step 502, then the DL carrier/BWP may correspond to the best SSB that the UE received. The best SSB may be the received SSB with the highest value of RSRP and/or RSRQ, for example.

Step 514 includes both the UE 406 and the BS 404 determining a random access radio network temporary identifier (RA-RNTI) for the UE 406. The RA-RNTI is an identifier that corresponds to the UE 406 and that may be used for traffic between the UE 406 and the BS 404. For example, the RA-RNTI may be used to identify the traffic that is being sent to and/or from the UE 406.

The RA-RNTI may be determined in step 514 based on a preconfigured rule. In some implementations, the RA-RNTI is based on the RACH resource and the UL carrier/BWP used for the PRACH transmission in step 510. For example, the RA-RNTI may be calculated based on an index of the RACH time resource, an index of the RACH frequency resource and an index of the UL carrier/BWP. Stated as an equation, RA-RNTI=f(RACH_t, RACH_f, UL_CC), where f is a function, RACH_t is the index of the RACH time resource, RACH_f is the index of the RACH frequency resource, and UL_CC is the index of the UL carrier/BWP. The index of the UL carrier/BWP may be indicated to the UE 406 by the BS 404, for example, with the system information transmitted in step 504. Alternatively or additionally, the index of the UL carrier/BWP could be determined by the UE 406 based on a preconfigured rule. An example of such a preconfigured rule is each candidate UL carrier/BWP being indexed in increasing or decreasing order of carrier/BWP frequency.

Determining the RA-RNTI based on the UL carrier/BWP used for the PRACH transmission in step 510 may help avoid collision when multiple candidate UL carriers/BWPs are configured for initial access. For example, two UEs could use RACH resources that are in different UL carriers/BWPs, but have the same RACH time resource index and the same RACH frequency resource index. If the RA-RNTIs for each UE are based only on the RACH time resource index and the RACH frequency resource index, then both UEs would be assigned the same RA-RNTI, which could result in collision. Therefore, determining RA-RNTIs based on UL carrier/BWP index may help ensure that different UEs performing initial access with different UL carriers/BWPs use different RA-RNTIs.

Step 516 includes the BS 404 transmitting an RAR back to the UE 406. The RAR may be transmitted on the DL carrier/BWP determined in step 512. As discussed in further detail elsewhere herein, the RAR may be transmitted on the same DL carrier/BWP that the UE 406 received the SSB and/or the system information on in steps 502, 504, or may be transmitted on another candidate DL carrier/BWP for initial access. The cyclical redundancy check (CRC) of downlink control information (DCI) scheduling the RAR may be scrambled using the RA-RNTI determined in step 514. The UE 406 may decode the DCI using the RA-RNTI and determine that the RAR is intended for the UE 406.

The RAR received by the UE 406 in step 516 may schedule a Msg3 transmission from the UE 406. In some implementations, the RAR supports cross-carrier scheduling among the candidate UL carriers/BWPs for initial access. For example, the RAR may indicate an UL carrier/BWP for the Msg3 transmission that is different from the UL carrier/BWP used to transmit the PRACH in step 510 and/or that is different from the DL carrier/BWP used to transmit the RAR in step 516. Cross-carrier scheduling may help provide load balance and/or interference coordination between the candidate UL carriers/BWPs.

In step 518, the UE 406 transmits Msg3 to the BS 404 on the UL carrier/BWP scheduled by the RAR. Step 520 then includes the BS 404 transmitting Msg4 to the UE 406. As discussed elsewhere herein, the DL carrier/BWP used to transmit Msg4 may be the same DL carrier/BWP used in step 516, or may be a different DL carrier/BWP. Steps 516, 518, 520 provide example implementations of steps 2, 3 and 4 of a contention-based initial access process.

After the process 500 is complete, the UE 406 may be connected to the BS 404. The active UL carrier/BWP following the process 500 may be the same UL carrier/BWP used to transmit Msg3 in step 518, and the active DL carrier/BWP may the same DL carrier/BWP used to transmit Msg4 in step 520.

It should be noted that the order of the steps shown in FIG. 10 is provided by way of example only. Other orders of these steps are also contemplated, and some steps may be performed in combination. For example, step 504 may be performed before step 502. Further, one or more of the steps shown in FIG. 10 might not be performed in some implementations of the process 500. For example, step 506 may be considered an optional step that need not be performed in all cases.

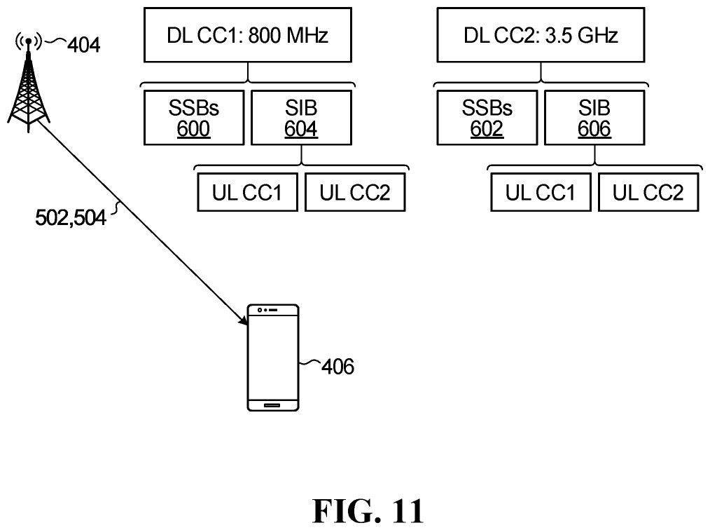

Various example implementations of the process 500 will now be described with reference to FIGS. 11 to 14.

FIG. 11 is a block diagram illustrating the BS 404 transmitting SSBs 600, 602 and SIBs 604, 606 to the UE 406 on different DL carriers/BWPs in steps 502, 504 of the process 500. These DL carriers/BWPs, which are illustrated as DL CC1 and DL CC2, are candidate DL carriers/BWPs configured for initial access. DL CC1 has a reference frequency of 800 MHz and DL CC2 has a reference frequency of 3.5 GHz. Each of the SIBs 604, 606 include an indication that multiple UL carriers/BWPs, illustrated as UL CC1 and UL CC2, are candidate uplink carriers/BWPs configured for initial access. In this way, the BS 404 transmits system information on different DL carriers/BWPs to indicate that the same two candidate UL carriers/BWPs are configured for initial access.

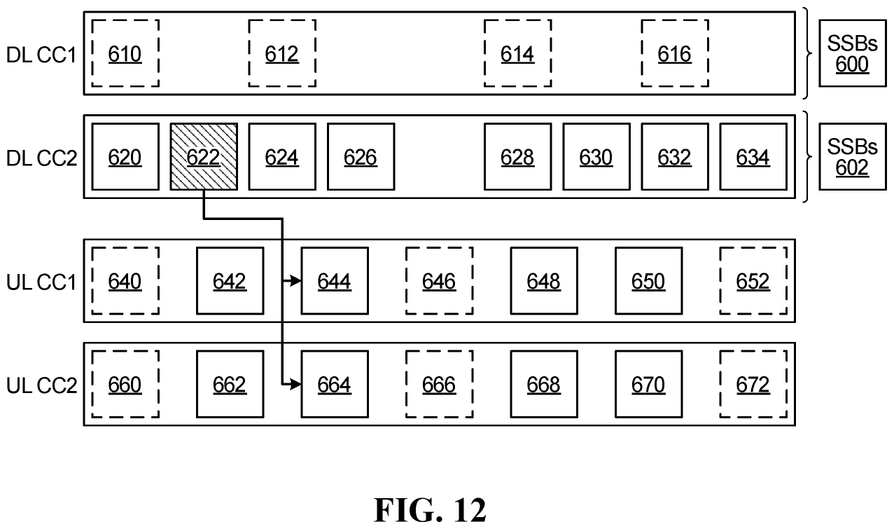

FIG. 12 is a block diagram illustrating an example resource configuration for DL CC1, DL CC2, UL CC1 and UL CC2 of FIG. 11. As illustrated, DL CC1 includes four SSB resources 610, 612, 614, 616 (shown with a dashed border) for transmitting the SSBs 600, and the DL CC2 includes eight SSB resources 620, 622, 624, 626, 628, 630, 632, 634 (shown with a solid border) for transmitting the SSBs 602. UL CC1 includes seven RACH resources 640, 642, 644, 646, 648, 650, 652 and the UL CC2 also includes seven RACH resources 660, 662, 664, 666, 668, 670, 672. Each of the RACH resources 640, 642, 644, 646, 648, 650, 652, 660, 662, 664, 666, 668, 670, 672 may have one or a plurality of corresponding RACH preambles. The RACH preambles for each of the RACH resources 640, 642, 644, 646, 648, 650, 652, 660, 662, 664, 666, 668, 670, 672 may be different, but this might not always be the case. The RACH resources 640, 642, 644, 646, 648, 650, 652, 660, 662, 664, 666, 668, 670, 672 and/or their corresponding preambles may be indicated in the SIBs 604, 606.

In some implementations, the SSBs 600 correspond to different DL beams on DL CC1 and/or the SSBs 602 correspond to different DL beams on DL CC2. For example, any, some or all of the SSB resources 610, 612, 614, 616, 620, 622, 624, 626, 628, 630, 632, 634 may be used to transmit the SSBs 600, 602 in a beam sweeping operation. The beam sweeping operation may be used to determine a DL beam between the BS 404 and the UE 406. If the UE 406 only receives one of the SSBs 600, 602 during the beam sweeping operation, then the DL beam used to transmit that SSB may be used for further communications between the BS 404 and the UE 406. Alternatively, the UE 406 may receive more than one of the SSBs 600, 602 during the beam sweeping operation and then determine the best SSB by comparing the reference signal received power (RSRP) and/or the reference signal received quality (RSRQ) for each the received SSBs, for example. This determination of the best SSB may indicate the best DL beam between the UE 406 and the BS 404 on DL CC1 and/or on DL CC2.

It should be noted that, as used herein, the “best beam” between two devices generally refers to the best performing beam that has been tested and/or measured. The “best beam” need not be the most optimal beam of all possible beams.

In some implementations, each of the SSBs 600, 602 (as well as each of the SSB resources 610, 612, 614, 616, 620, 622, 624, 626, 628, 630, 632, 634) correspond to one or more of the RACH resources 640, 642, 644, 646, 648, 650, 652, 660, 662, 664, 666, 668, 670, 672. For example, the SSB resource 610 may correspond to the RACH resources 640, 660, the SSB resource 620 may correspond to the RACH resources 642, 644, and the SSB resource 622 may correspond to the RACH resources 644, 664. In general, the RACH resources 640, 646, 652, 660, 666, 672 are shown with a dashed border in FIG. 12 to indicate a correspondence with the SSBs 600, and the RACH resources 642, 644, 648, 650, 662, 664, 668, 670 are shown with a solid border to indicate a correspondence with the SSBs 602. The correspondence between a RACH resource and an SSB may mean that, when the UE 406 receives the SSB and optionally determines that the SSB is the best received SSB, then the UE 406 may use the corresponding RACH resource to transmit a PRACH in step 510.

The correspondence between an SSB resource and one or more RACH resources may be a unique correspondence. For example, the SSB resource 622 may be the only SSB resource that corresponds to either of the RACH resources 644, 664. In this way, the RACH resources 640, 642, 644, 646, 648, 650, 652, 660, 662, 664, 666, 668, 670, 672 and/or their corresponding RACH preambles may be used to uniquely identify a corresponding SSB resource.

Based on the correspondence between an SSB and one or more RACH resources, the BS 404 may be able to derive which DL carrier and/or DL beam to use when transmitting the RAR to the UE 406 in step 516. Without such a correspondence, the BS 404 might not be able to determine which DL carrier the UE 406 is monitoring for an RAR. Consider an example in which the UE 406 receives one or more SSBs on the SSB resources 610, 612, 614, 616, 620, 622, 624, 626, 628, 630, 632, 634 in step 502. Of the received SSBs, the UE 406 may determine that the SSB received on the SSB resource 622 is the best SSB, which may be based on the RSRP and/or the RSRQ of this SSB, for example. Hatching is used in FIG. 12 to illustrate the SSB transmitted on the SSB resource 622 being the best SSB received by the UE 406. Based on the SIB 606, the UE 406 may determine that the RACH resources 644, 664 correspond to the SSB resource 622 and may be used transmit a PRACH to the BS 404 in step 510. The UE 406 may choose between the RACH resources 644, 646 for transmitting the PRACH, which may be based on a selection of either UL CC1 or UL CC1 in step 508. For example, in step 508, the UE 406 may use assistance information to select either UL CC1 or UL CC2 for the PRACH transmission. Alternatively or additionally, only one of UL CC1 and UL CC2 may be identified as an available UL carrier by the SIB 606, and the UE 406 may select the UL carrier that is available. If UL CC1 is selected in step 508, then the UE 406 may use the RACH resource 644 for the PRACH transmission or, if UL CC2 is selected, then the UE 406 may use the RACH resource 664.

The use of the RACH resources 644, 664 to transmit the PRACH in step 510 will implicitly inform the BS 404 that the SSB received in the SSB resource 622 is the best (or only) SSB received by the UE 406. The BS 404 may then determine that the DL beam used in the SSB resource 622 is the best DL beam between the BS 404 and the UE 406. Further, the use of the RACH resources 644, 664 to transmit the PRACH will implicitly inform the BS 404 that the UE 406 is monitoring DL CC2 for the RAR. Therefore, the BS 404 may send the RAR on DL CC2 in step 516. The determination of the DL beam and the DL carrier may be performed by the BS 404 in step 512.

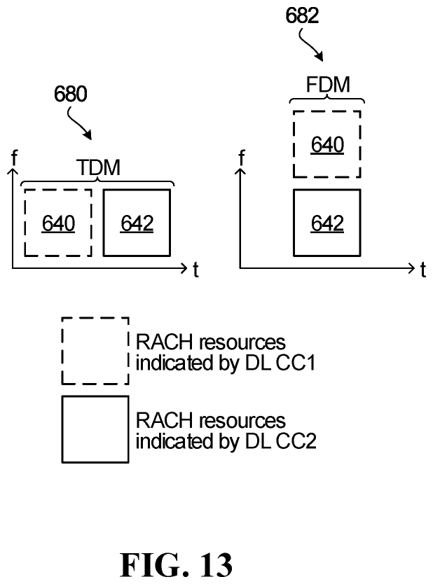

TDM or FDM may be used to configure the RACH resources 640, 642, 644, 646, 648, 650, 652, 660, 662, 664, 666, 668, 670, 672 on UL CC1 and UL CC2. FIG. 13 is a diagram illustrating two time-frequency plots 680, 682 that include the RACH references 640, 642. The plot 680 includes an example TDM configuration of the RACH resources 640, 642 and the plot 682 includes an example FDM configuration of the RACH resources 640, 642.

In some implementations, the same RACH resource may correspond to an SSB resource on DL CC1 and to another SSB resource on DL CC2. The UE 406 may then transmit different RACH preambles using the RACH resource to indicate which SSB resource the UE 406 received an SSB on. For example, the RACH resources 640, 642 could actually be the same resource, but different RACH preambles and/or different RACH preamble formats may be sent using the RACH resource in step 510 depending on whether an SSB (or the best SSB) is received using the SSB resource 610 or the SSB resource 620. The different RACH preambles and/or different RACH preamble formats may enable the BS 404 to determine which DL carrier/BWP the UE 406 is monitoring for an RAR. Examples of different RACH preambles include different preamble sequences. Examples of different RACH formats include different lengths of preambles sequences, such as long and short preamble sequences.

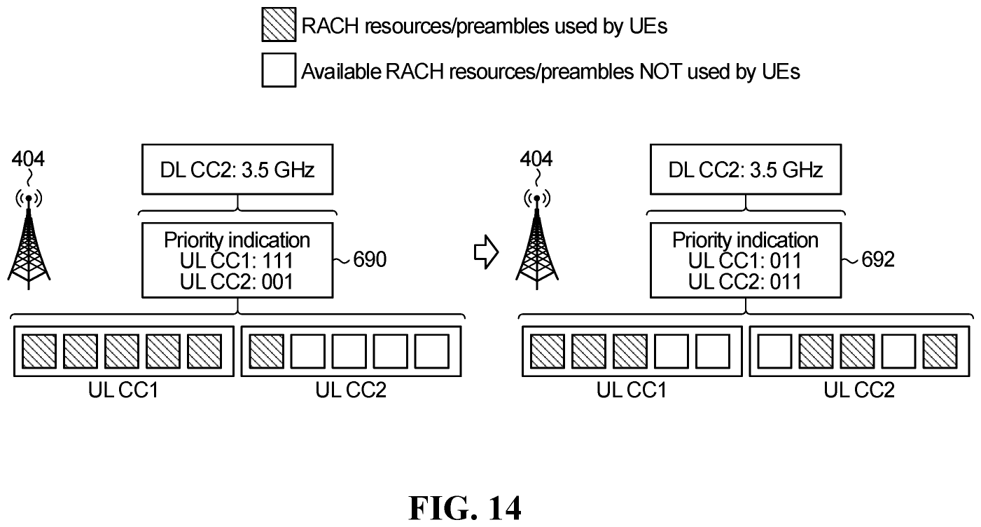

Examples of the priority indication that may be transmitted in step 506 of the process 500 will now be described. FIG. 14 is a diagram illustrating priority indications 690, 692 for UL CC1 and UL CC2 of FIGS. 11 and 12. In the illustrated example, the priority indications 690, 692 are transmitted on DL CC2. The priority indication 690 corresponds to a first instance in time where all seven of the RACH resources on UL CC1 are being used by UEs in initial access processes, and only one of the seven RACH resources on UL CC2 is being used in initial access processes. The other six RACH resources in UL CC2 are available RACH resources not being used by UEs. The priority indication 690 is based on the number of used and available RACH resources in UL CC1 and UL CC2. The priority indication 960 includes a relatively high binary value of “111” for UL CC1 to indicate that there is a heavy traffic load and/or a high probability of RACH collision on UL CC1. A lower binary value of “001” is included in the priority indication 960 for UL CC2 to indicate a lower traffic load and/or a lower probability of RACH collision on UL CC2. Based on the priority indication 960, the UE 406 may select UL CC2 for transmitting the PRACH in step 508, for example.

The priority indication 692 corresponds to a second instance in time where three RACH resources are being used by UEs on each of UL CC1 and UL CC2, and two RACH resources are available on each of UL CC1 and UL CC2. Based on the numbers of used and available RACH resources on UL CC1 and UL CC2, the priority indication 692 includes the same binary value of “011” for each UL carrier to indicate that UL CC1 and UL CC2 have approximately the same traffic load and/or probability of RACH collision. Therefore, based on the priority indication 962, the UE 406 may randomly select one of UL CC1 or UL CC2 in step 508, or select one of UL CC1 or UL CC2 based on another criterion.

In some implementations, the priority indication 960 may help balance the traffic load on CC1 and CC2 for the second instance in time. For example, based on the priority indication 960, UEs may select UL CC2 for initial access, resulting in a more balanced use of RACH resources between UL CC1 and UL CC2.

It should be noted that the use of multiple carriers/BWPs during initial access is not limited to contention-based initial access processes. Contention-free initial access processes utilizing multiple carriers/BWPs are also contemplated.

In some embodiments, a BS transmits, to a UE, an indication to perform a contention-free initial access process using a dedicated RACH preamble. The RACH preamble may be provided through control signaling, such as RRC signaling or DCI on a PDCCH, for example. Further, the BS may also indicate the DL and/or UL carriers/BWPs for the initial access process. By way of example, through RRC signaling or DCI, the BS may indicate the UL carrier/BWP index on which UE sends a PRACH. The UL carrier/BWP may be selected by the BS from multiple candidate UL carriers/BWPs. Alternatively or additionally, through RRC signaling or DCI, the BS may indicate the DL carrier/BWP index that UE monitors for an RAR, which may be selected by the BS from multiple candidate DL carriers/BWPs.

After receiving the RACH preamble, the UL carrier/BWP index and/or the DL carrier/BWP index for initial access, the UE may transmit the RACH preamble to the BS on the indicated UL carrier/BWP in a PRACH transmission. The UE may then monitor for an RAR on the indicated DL carrier/BWP. Advantageously, indicating the UL and/or DL carriers/BWPs for a contention-free initial access process may enable flexible UL and DL spectrum utilization during the initial access process.

### Reducing SSB Overhead

SSB resources may contribute to synchronization overhead in a wireless communication system. In some cases, a BS might not send SSBs on all candidate DL spectral resources that are configured for initial access in order to help reduce synchronization overhead. For example, if there are multiple non-contiguous carriers/BWPs in low-frequency bands and each carrier/BWP has a relatively small bandwidth, then sending an SSB on each carrier/BWP may result in significant synchronization overhead. Reducing the number of carriers/BWPs that carry an SSB may reduce this synchronization overhead.

In some embodiments, multiple spectral resources are combined into, or otherwise regarded as, a super wideband carrier. SSB resources may be included in only one spectral resource of the super wideband carrier, but the information obtained using the SSB resource may be used to configure communications on any of the spectral resources. For example, the synchronization information obtained from the SSB may be used for synchronizing to any of the spectral resources in the super wideband carrier. In this way, a super wideband carrier may have a lower synchronization overhead when compared to multiple independent spectral resources that each include respective SSB resources.

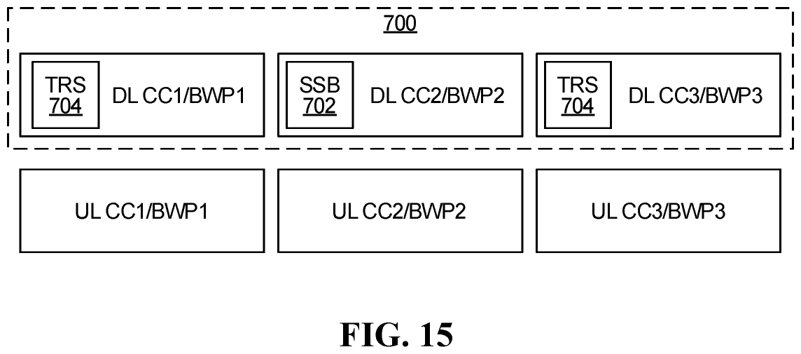

FIG. 15 is a block diagram illustrating an example of a super wideband carrier 700, according to an embodiment. The super wideband carrier 700 includes three candidate DL carriers/BWPs for initial access, shown as DL CC1/BWP1, DL CC2/BWP2 and DL CC3/BWP3. In some implementations, DL CC2/BWP2 has a bandwidth of 10 MHz, and DL CC1/BWP1 and DL CC3/BWP3 each have a bandwidth of 5 MHz. FIG. 15 also illustrates three candidate UL carriers/BWPs for initial access, shown as UL CC1/BWP1, UL CC2/BWP2 and UL CC3/BWP3.

An SSB resource 702 is included in DL CC2/BWP2 to transmit a corresponding SSB. However, no SSB resources are included in DL CC1/BWP1 or DL CC3/BWP3. Instead, tracking reference signal (TRS) resources 704 are included in DL CC1/BWP1 and DL CC3/BWP3 to transmit corresponding TRSs. The TRSs may enable time tracking, frequency tracking, path delay spread tracking and/or Doppler spread tracking on DL CC1/BWP1 and DL CC3/BWP3. Transmitting only one SSB on the super wideband carrier 700 may reduce SSB overhead when compared to transmitting an SSB on each of DL CC1/BWP1, DL CC2/BWP2 and DL CC3/BWP3.

Some embodiments of the present disclosure enable the flexible utilization of DL spectral resources in a super wideband carrier during initial access, even when SSB resources are not included in each carrier/BWP of the super wideband carrier. For example, the super wideband carrier 700 may be used in a contention-based initial access process, such as the process 500 of FIG. 10. The SSB transmitted on DL CC2/BWP2 using the SSB resource 702 may be received by a UE in step 0 of the initial access process. The SSB may allow the UE to perform DL synchronization and/or to determine a DL beam for the super wideband carrier 700. The DL synchronization and/or the DL beam may enable communication over DL CC1/BWP1, DL CC2/BWP2 and/or DL CC3/BWP3. The UE may then transmit a PRACH to the BS on UL CC1/BWP1, UL CC2/BWP2 or UL CC3/BWP3 in step 1 of the initial access process.

In some embodiments, an RAR received by the UE in step 2 of the initial access process is used to indicate a DL carrier/BWP for one or more DL transmissions. For example, the RAR may include a DL carrier/BWP index for the one or more DL transmissions. These DL transmissions may include a Msg4 transmission in step 4 of the initial access process. For example, after transmitting the PRACH to the BS, the UE may then monitor DL CC2/BWP2 for an RAR sent from the BS. The RAR may indicate a Msg4 transmission on DL CC1/BWP1, DL CC2/BWP2 and/or DL CC3/BWP3 of the super wideband carrier 700. After receiving the RAR, the UE knows which DL carrier/BWP of the super wideband carrier 700 to monitor for a Msg4 transmission.

A DL carrier/BWP for the Msg4 transmission may be indicated by an RAR in any of a number of different ways. In some embodiments, each DL carrier/BWP of the super wideband carrier 700 may be indexed and the RAR may indicate the index of the DL carrier/BWP for the Msg4 transmission. The indices of DL CC1/BWP1, DL CC2/BWP2 and DL CC3/BWP3 may be indicated by the BS in system information received by the UE in step 0 of the initial access process. Alternatively or additionally, the indices of DL CC1/BWP1, DL CC2/BWP2 and DL CC3/BWP3 may be determined by the UE based on a predefined rule. An example of such a predefined rule is indexing the DL carriers/BWPs in order of increasing or decreasing reference frequency.

By indicating the DL carrier/BWP for the Msg4 transmission in an RAR, step 4 of the initial access process may be performed by a DL carrier/BWP of the super wideband carrier 700 that does not carry an SSB. This DL carrier/BWP may remain active for the UE after the initial access process.

An RAR might not always be sent to the UE on DL CC2/BWP2 during an initial access process. An RAR may instead be sent on another DL carrier/BWP of the super wideband carrier 700 that does not include an SSB resource. For example, after receiving the SSB on DL CC2/BWP2 and transmitting a PRACH to the BS, the UE may monitor another DL carrier/BWP of the super wideband carrier 700 for an RAR. The UE may indicate this other DL carrier/BWP using the PRACH transmission. For example, system information provided to the UE in step 0 of the initial access process may indicate multiple RACH resources and/or multiple RACH preambles that correspond to the different DL carriers/BWPs of the super wideband carrier 700. The UE may then select a particular RACH resource and/or RACH preamble to indicate which DL carrier/BWP the UE will monitor to an RAR.

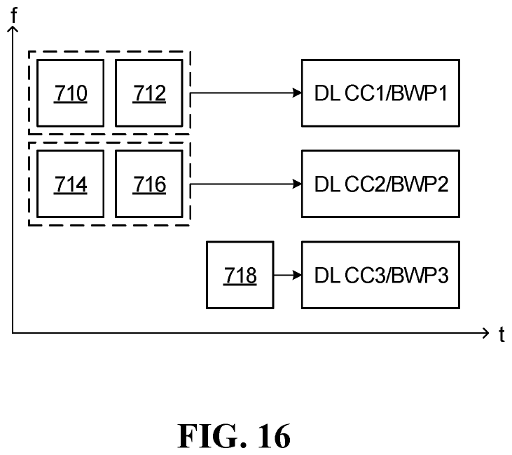

An example of RACH resources corresponding to different DL carriers/BWPs of a super wideband carrier is shown in FIG. 16. FIG. 16 is a time-frequency plot illustrating multiple RACH resources 710, 712, 714, 716, 718 corresponding to DL CC1/BWP1, DL CC2/BWP2 and DL CC3/BWP3 of the super wideband carrier 700. As illustrated, the RACH resources 710, 712 correspond to DL CC1/BWP1, the RACH resources 714, 716 correspond to DL CC2/BWP2, and the RACH resource 718 corresponds to DL CC3/BWP3. All of the RACH resources 710, 712, 714, 716, 718 correspond to the SSB resource 702 in DL CC2/BWP2. For example, any of the RACH resources 710, 712, 714, 716, 718 may be used to transmit a PRACH after receiving the SSB. The RACH resources 710, 712, 714, 716, 718 may be utilize any, one, some or all of UL CC1/BWP1, UL CC2/BWP2 and UL CC3/BWP3.

After the UE receives the SSB and system information indicating the RACH resources 710, 712, 714, 716, 718, the UE may select a DL carrier/BWP on the super wideband carrier 700 to monitor for an RAR transmission. The UE may then send a PRACH using a RACH resource and/or a RACH preamble that corresponds to the selected DL carrier/BWP. Alternatively, the UE may select a RACH resource for the PRACH transmission, and then determine the DL carrier/BWP to monitor for the RAR based on the selected RACH resource. For example, if the PRACH is transmitted using the RACH resource 712, then the BS may determine that the UE is monitoring DL CC1/BWP1 for the RAR. The Msg 4 transmission may also be transmitted on DL CC1/BWP1 based on the use of the RACH resource 712 to transmit the PRACH. For example, the DL carrier/BWP for Msg4 may be predefined as being the same DL carrier/BWP used for the RAR. Alternatively or additionally, the DL carrier/BWP for Msg4 may be indicated by the RAR.

Advantageously, although an SSB is only transmitted on DL CC2/BWP2 of the super wideband carrier 700 , DL CC1/BWP1 and DL CC3/BWP3 may still be utilized during initial access. For example, an RAR transmission and/or a Msg4 transmission may be performed using DL CC1/BWP1 and/or DL CC3/BWP3. In this way, the super wideband carrier 700 may reduce SSB overhead while also allowing different DL spectral resources to be accessed during initial access. Enabling the flexible utilization of DL CC1/BWP1, DL CC2/BWP2 and DL CC3/BWP3 during initial access may help provide load balance on the super wideband carrier 700.

### Determining UL Beams During Initial Access

As noted above, a UE may receive one or more SSBs transmitted by a BS to determine a DL beam between the UE and the BS. For example, multiple SSBs may be transmitted as part of a beam sweeping operation, and the UE may determine the best DL beam based on the best received SSB. However, the determined DL beam might not correspond to a suitable UL beam for use in transmissions from the UE to the BS. The beam information and/or the precoding information for the DL beam might not apply to the UL beam. In this way, the DL beam and the UL beam between the UE and the BS may have limited reciprocity.

In some cases, a beam may depend on carrier/BWP frequency. If a DL carrier/BWP and an UL carrier/BWP are in different spectral ranges, then the DL beam may differ from the UL beam. For example, a DL carrier/BWP with a reference frequency of 28 GHz may have a different beam than a UL carrier/BWP with a reference frequency of 3.5 GHz.

In some cases, a DL carrier/BWP and an UL carrier/BWP may be utilized by different transmission and reception points (TRPs) in a network. The TRPs may also be of different types, including macro-TRPs, small-TRPs, pico-TRPs, femto-TRPs and relay-TRPs, for example. A DL beam might be between a UE and one TRP, and an UL beam might be between the UE and another TRP. The directions of the DL beam and the UL beam may therefore differ.

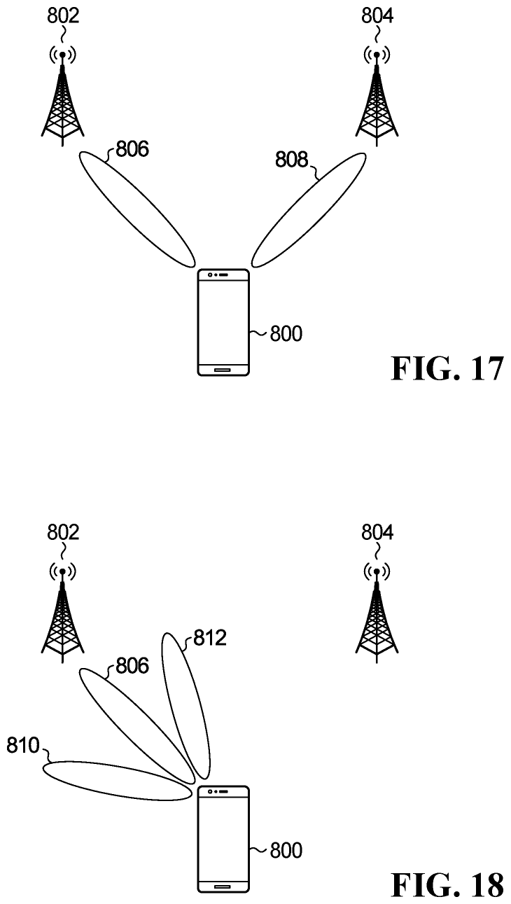

FIG. 17 is a diagram illustrating a UE 800 communicating with two TRPs 802, 804 via respective beams 806, 808, according to an embodiment. FIG. 17 provides an example of dual connectivity (DC) for the UE 800. Either or both of the TRPs 802, 804 may be similar to the T-TRP 170 or to the NT-TRP 172 of FIGS. 1 to 3, and/or the UE 800 may be similar to the ED 110 of FIGS. 1 to 3.

In some implementations, the TRP 802 is a low-frequency TRP that provides UL coverage for the UE 800 on a low-frequency UL carrier/BWP. For example, the TRP 802 may provide a supplementary UL (SUL) channel to improve UL coverage range. The TRP 804 is a high-frequency TRP that provides DL coverage for the UE 800 on a high-frequency DL carrier/BWP to improve DL data throughput. The beam 806 is used for UL transmissions between the UE 800 and the TRP 802, and the beam 808 is used for DL transmissions between the UE 800 and the TRP 804.

In other implementations, the TRPs 802, 804 may both utilize the same carrier/BWP, but the TRP 802 is a macro-cell and the TRP 804 is a pico-cell. This is an example of a heterogenous network. The UE 800 may be within the UL coverage range of the TRP 804, but be outside of the DL coverage range of the TRP 804. The TRP 804 may therefore provide UL coverage for the UE 800 using the beam 808, while the TRP 802 provides DL coverage using the beam 806. The DL association of the UE 800 to the TRP 802 may be established based on the RSRP and/or RSRQ of an SSB sent from the TRP 802. The UL association of the UE 800 to the TRP 804 may be based on an UL pathloss between the UE 800 and the TRP 804.

In further implementations, the TRP 802 is a normal transmit and receive TRP and the TRP 804 is a receive-only TRP. Receive-only TRPs may be deployed as low-cost options to improve UL coverage in a network. The TRP 804 provides UL coverage for the UE 800 on the beam 808, and the TRP 802 provides UL and/or DL coverage for the UE 800 on the beam 806.

The limited reciprocity between DL and UL beams for a UE might mean that the UE is not able to determine an UL beam from a known DL beam. As a result, the UL beam might be determined independently of the DL beam. For example, in the case that a UE determines a DL beam using an SSB received in step 0 of a contention-based initial access process, the UE might still need to determine an UL beam. Some embodiments of the present disclosure provide initial access processes that enable a UE to determine a suitable UL beam.

In some embodiments, a BS may indicate one or more candidate UL beams for a UE. Indicating the candidate UL beams may include providing beam information and/or precoding information for each of the candidate UL beams. The candidate UL beams may be indicated in system information received in step 0 of a contention-based initial access process, for example. The candidate UL beams may correspond to different RACH resources that are also indicated in the system information. The correspondence between the candidate UL beams and the RACH resources could be based on the carrier/BWP and/or the TRP for each RACH resource. In one example, if the RACH resources correspond to multiple candidate UL carriers/BWPs, then a different UL beam may be indicated for the RACH resources in each candidate UL carrier/BWP. In another example, if the RACH resources correspond to multiple TRPs, then a different UL beam may be indicated for the RACH resources corresponding to each TRP.

A BS may determine one or more candidate UL beams for a UE in any of a number of different ways. In some embodiments, the BS may determine an UL beam based on sensing information and/or positioning information for a UE. For example, an AI/ML model may predict an UL beam for the UE using sensing information and/or positioning information as inputs. The AI/ML model may be trained using a training data set including the beam information for multiple UL beams, and sensing and/or positioning information for UEs corresponding to each of those UL beams. The trained AI/ML model might then use UE sensing and/or positioning information as inputs, and output a potential UL beam.

In some embodiments, a transmit (Tx) beam sweeping operation is performed by a UE during a contention-based initial access process to determine an UL beam. For example, the UE may perform multiple PRACH transmissions on respective UL beams during step 1 of the initial access process. The best PRACH transmissions received by a TRP may indicate the best UL beam between the UE and the TRP.

FIG. 18 is a block diagram illustrating a Tx beam sweeping operation during step 1 of a contention-based initial access process, according to an embodiment. As illustrated, the UE 400 performs PRACH transmissions on multiple UL beams 806, 810, 812. Each PRACH transmission may correspond to a different RACH resource and/or to a different RACH preamble. The TRP 802 may determine that the best received PRACH is transmitted on UL beam 806, and thereby determine that the UL beam 806 is the best UL beam between the UE 800 and the TRP 802. If multiple PRACH transmissions are received or detected at the TRP 802, then the TRP 802 may determine the best received PRACH based on the RSRP and/or RSRQ of the received PRACHs. Alternatively or additionally, after the TRP 802 successfully blind decodes a RACH preamble in one PRACH transmission, the TRP 802 may consider that PRACH transmission to be the best PRACH transmission. The Tx beam sweeping operation shown by way of example in FIG. 18 may also be considered a PRACH beam sweeping operation.

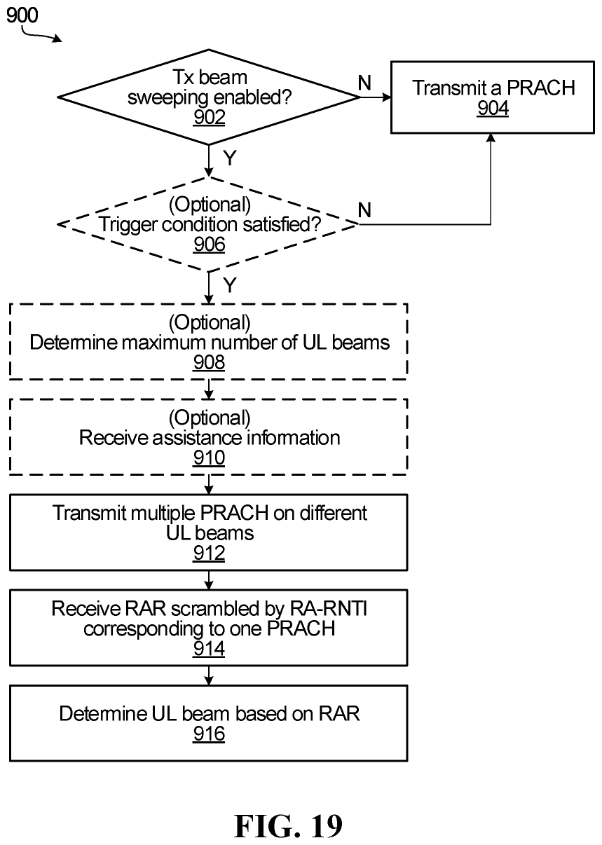

FIG. 19 is a flow diagram illustrating a method 900 for implementing Tx beam sweeping during a contention-based initial access process, according to an embodiment. The method 900 may be performed by a UE. For example, the method 900 could be performed by the UE 406 during the process 500 to determine an UL beam between the UE 406 and the BS 404.

Step 902 includes the UE determining whether Tx beam sweeping is enabled for the UE. In some implementations, a BS provides the UE with an indication of whether or not Tx beam sweeping is enabled. This indication may be transmitted with system information in step 0 of the initial access process, for example. If multiple candidate UL carriers/BWPs are configured for the initial access process, then the BS may provide a single indication of Tx beam sweeping enablement for all of the candidate UL carriers/BWPs. Alternatively, a separate indication of Tx beam sweeping enablement may be provided for each of the candidate UL carriers/BWPs. Some candidate UL carriers/BWPs may have Tx beam sweeping enabled, while others might not have Tx beam sweeping enabled. For example, if a DL carrier/BWP and a first UL carrier/BWP are in the same frequency spectrum band and correspond to the same TRP, then an UL beam on the first UL carrier/BWP may be determined based on the DL beam. Therefore, the BS may indicate that Tx beam sweeping is not enabled on the first UL carrier/BWP. If the DL carrier/BWP and a second UL carrier/BWP are in different frequency bands, then the BS may indicate that Tx beam sweeping on the second UL carrier/BWP is enabled to determine an UL beam on the second UL carrier/BWP.

In the case that the UE determines Tx beam sweeping is not enabled for an UL carrier/BWP selected for initial access by the UE, then the method 900 may proceed to step 904. In step 904, the UE transmits a single PRACH on the selected UL carrier/BWP using a RACH resource. No Tx beam sweeping is performed in step 904. Step 904 may correspond to step 1 of a contention-based initial access process.

In the case that Tx beam sweeping is enabled on the selected UL carrier, then the method 900 may proceed to optional step 906 or to optional step 908.

Step 906 includes the UE determining if a trigger condition for Tx beam sweeping is satisfied. The trigger condition may be indicated to the UE in system information sent by the BS. In some implementations, the trigger condition may include a RSRP threshold for a received SSB. If the RSRP of an SSB received by the UE is less than the RSRP threshold, then the trigger condition may be satisfied and the UE could perform Tx beam sweeping. For example, a low RSRP may indicate that a UE is at a cell edge, and the Tx beam sweeping may enable the UE to connect to a neighboring TRP for UL communications. A trigger condition may also or instead include a RSRQ threshold for a received SSB.

In the case that the trigger condition is not satisfied, then the method 900 may proceed from step 906 to step 904. Alternatively, in the case that the trigger condition is satisfied, then the method 900 may proceed to optional step 908.

Optional step 908 includes the UE determining a maximum number of UL beams for Tx beam sweeping. In some implementations, the maximum number of UL beams is predefined at the UE. Alternatively or additionally, the BS may indicate the maximum number of UL beams in system information, for example. The maximum number of UL beams may be the same for all candidate UL carriers/BWPs, or the maximum number of UL beams may be UL carrier/BWP-dependent. For example, the maximum number of UL beams determined in step 908 may depend on the particular UL carrier/BWP selected by the UE for initial access. In some implementations, the larger the frequency difference between a DL carrier/BWP and an UL carrier/BWP for initial access, the larger the maximum number of UL beams.

In optional step 909, the UE receives assistance information for Tx beam sweeping from the BS. The assistance information may indicate whether a UL carrier/BWP corresponds to another TRP, different from the BS utilizing the DL carrier/BWP. The UE may then configure the Tx beam sweeping process to determine an UL beam to the other TRP.

Step 910 includes the UE performing multiple PRACH transmissions on different UL beams. The number of PRACH transmissions may equal the maximum number of UL beams determined in step 908. Further, the direction of each UL beam may be determined based, at least in part, on the assistance information received in step 909. Step 910 may correspond to step 1 of a contention-based initial access process.

The RACH resources and/or the RACH preambles used for each of the PRACH transmissions in step 910 may correspond to an SSB received by the UE. Each of the RACH resources might not overlap in the time-domain. For example, the RACH resources may be time-division multiplexed, which may provide sequential Tx beam sweeping. For each PRACH transmission, the UE may calculate a corresponding RA-RNTI. As discussed in further detail elsewhere herein, an RA-RNTI for a PRACH transmission may be calculated based on the RACH resource and/or based on the UL carrier/BWP used for the PRACH transmission. The UE may then monitor for RARs scheduled by DCI scrambled with any of the RA-RNTIs corresponding to the PRACH transmissions.

The BS, or another TRP providing UL coverage for the UE, may receive one or more of the PRACH transmissions from the UE. As noted above, if multiple PRACH transmissions are received, then the best PRACH transmission may be selected based on RSRP, RSRQ and/or the first RACH preamble to be successfully decoded. The BS or other TRP may then determine the RA-RTNI for the best (or only) received PRACH transmission, and transmit an RAR scheduled by DCI with a CRC that is scrambled by the RA-RNTI. The best (or only) received PRACH transmission may correspond to the best UL beam between the UE and the BS or other TRP. Therefore, although multiple PRACH transmissions are performed by the UE in step 910, only one RAR may be transmitted to the UE.

In step 912, the UE receives the RAR from the BS or other TRP. Next, in step 914, the UE determines the best UL beam based on the received RAR. The RA-RNTI that is used to scramble the DCI scheduling the RAR may indicate the best UL beam. The UE may attempt to decode the DCI/RAR using any, one, some or all of the RA-RNTIs corresponding to the PRACH transmissions. Decoding the DCI/RAR may include descrambling the CRC of the DCI using an RA-RNTI. When the UE successfully decodes the DCI/RAR using a particular RA-RNTI, the UE could derive the corresponding RACH resource, PRACH transmission and/or UL beam based on that RA-RNTI. The derived UL beam may be regarded as the best UL beam between the UE and the BS or other TRP. The UE may determine the beam information and/or the precoding information for the best UL beam, and may use this information to perform a Msg 3 transmission on the best UL beam in the contention-based initial access process.

It should be noted that the order of the steps shown in FIG. 19 is provided by way of example only. Other orders of these steps are also contemplated, and some steps may be performed in combination.

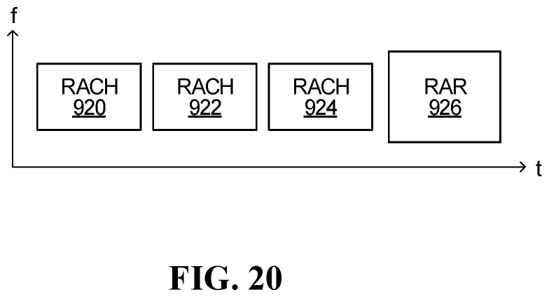

An example of Tx beam sweeping during an initial access process is shown in FIG. 20. FIG. 20 is a time-frequency plot including multiple RACH resources 920, 922, 924 for Tx beam sweeping, according to an embodiment. The time-frequency plot also includes an RAR resource 926. The RACH resources 920, 922, 924 may all correspond to a single SSB resource and could be used in a Tx beam sweeping operation. For example, a UE could use each of the RACH resources 920, 922, 924 to transmit a respective PRACH on a different UL beam. The UE may then receive an RAR from a BS on the RAR resource 926. The UE may determine a RA-RNTI for each of the RACH resources 920, 922, 924, and attempt to decode the DCI scheduling the RAR using each of the RA-RNTIs. The RA-RNTI that successfully decodes the DCI/RAR may indicate the best UL beam between the UE and the BS. By way of example, if the RA-RNTI calculated based on the RACH resource 922 can successfully decode the DCI/RAR, then the UE may determine that the UL beam corresponding to the RACH resource 922 is the best UL beam between the UE and the BS. The UE may then use the UL beam to perform a Msg 3 transmission to the BS.

Advantageously, when DL and UL beams have limited reciprocity in an initial access process, Tx beam sweeping could improve initial access success rate and reduce the latency of initial access. For example, by determining the best UL beam, the UL transmission failure rate may decrease, which might improve the success rate of initial access. Without Tx beam sweeping during initial access, a UE may transmit a PRACH on an UL beam and then wait for the transmission of an RAR. If the UE does not receive the RAR and determines that the PRACH transmission has failed, then the UE may transmit another PRACH, which may use another UL beam. However, waiting for the UE to determine that the first PRACH transmission has failed may increase the latency of initial access. In this way, Tx beam sweeping may reduce initial access latency by avoiding the delay associated with waiting to determine that a first PRACH transmission has failed before sending a PRACH on another UL beam.

### General Examples

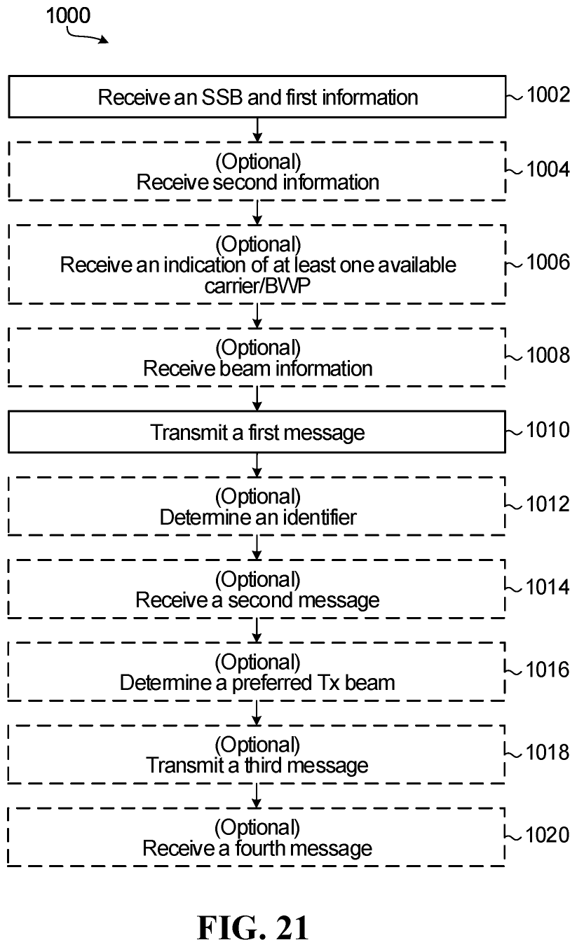

FIG. 21 is a flow diagram illustrating a method 1000 for an apparatus in a wireless communication network, according to an embodiment. The method 1000 will be described as being performed by an apparatus having at least one processor, a computer readable storage medium, a transmitter and a receiver. In some implementations, the computer readable storage medium is operatively coupled to the at least one processor and stores programming for execution by the at least one processor. The programming may include instructions to perform the method 1000. In some implementations, the apparatus is a UE or ED, such as the ED 110 of FIGS. 1 to 3, for example.

The method 1000 may be considered part of a contention-based initial access process, in which the apparatus establishes communication with one or more network devices. Examples of the network devices include the T-TRP 170 and the NT-TRP 172 of FIGS. 1 to 3. The method 1000 may implement multiple DL carriers/BWPs, multiple UL carriers/BWPs, multiple DL beams and/or multiple UL beams for communication between the apparatus and the one or more network devices.

Step 1002 includes the receiver of the apparatus receiving an SSB and first information. The SSB and first information may be received on a first DL carrier/BWP from a network device. The first information may include system information, such as an SIB, for example. The first information indicates a plurality RACH resources corresponding to a plurality of carriers/BWPs and/or to a plurality of beams. Steps 502, 504 of the process 500 of FIG. 10 provide an example of step 1002.

In some implementations, the plurality of RACH resources corresponds to a plurality of UL carriers/BWPs for random access. The plurality of RACH resources may further correspond to the first DL carrier/BWP. For example, each of the plurality of RACH resources may include at least one of a time resource, a frequency resource, a RACH preamble or a RACH format that is indicative of the SSB being received over the first DL carrier/BWP.

The plurality of RACH resources may further correspond to a plurality of DL carriers/BWPs for random access, including the first DL carrier/BWP. FIG. 12 illustrates an example of RACH resources corresponding to a plurality of UL carriers/BWPs and/or to a plurality of DL carriers/BWPs.

Optional step 1004 includes the receiver of the apparatus receiving second information pertaining to the plurality of UL carriers/BWPs. This second information may be considered assistance information to help the apparatus select an UL carrier/BWP from the plurality of UL carriers/BWPs. The second information may include at least one of a traffic load, an interference degree, a RACH collision ratio, a successful RACH ratio or a priority indication for at least one of the plurality of UL carriers/BWPs. Step 506 of the process 500 provides an example of step 1004.

Optional step 1006 includes the receiver of the apparatus receiving an indication of at least one available UL carrier/BWP within the plurality of UL carriers/BWPs. The at least one available UL carrier/BWP may include an UL carrier/BWP with the lowest traffic load, lowest interference degree, lowest RACH collision ratio and/or highest successful RACH ratio, for example.

In some implementations, the plurality of RACH resources corresponds to a plurality of Tx beams. Optional step 1008 includes the receiver of the apparatus receiving beam information for the plurality of Tx beams. The beam information may be based on sensing information and/or position information corresponding to the apparatus. In this way, the plurality of Tx beams may be specifically configured for the apparatus.

Optional step 1008 may also or instead include the receiver of the apparatus receiving other indications, such as an indication to enable beam sweeping. This beam sweeping may include transmitting a plurality of messages using the plurality of RACH resources and at least some of the plurality of Tx beams. Alternatively or additionally, step 1008 may include the receiver of the apparatus receiving an indication of a trigger condition or another condition for beam sweeping. The at least one processor of the apparatus may determine if the condition is met based on the properties of the SSB received in step 1002. Alternatively or additionally, step 1008 may include the receiver of the apparatus receiving an indication of a neighboring network device for the beam sweeping, which may be considered a form of assistance information. For example, the SSB may be transmitted by a first network device, and the indication received in step 1008 may indicate a second network device for uplink communication. Alternatively or additionally, step 1008 may include the receiver of the apparatus receiving an indication of a maximum number of messages to transmit in a beam sweeping operation. Steps 902, 906, 908, 909 of the method 900 of FIG. 19 provide examples of step 1008.

Step 1010 includes the transmitter of the apparatus transmitting a first message using a first RACH resource of the plurality of RACH resources. The first message may be a PRACH that is transmitted on a first UL carrier/BWP. The first UL carrier/BWP may be in a different frequency band than the first DL carrier/BWP. In some implementations, the first UL carrier is included in the plurality of UL carriers corresponding to the plurality of RACH resources. The first RACH resource of the plurality of RACH resources may correspond to the first UL carrier/BWP.

In some implementations, if second information is received in step 1004, then step 1010 may include the at least one processor of the apparatus selecting, based on the second information, the first UL carrier/BWP from the plurality of UL carriers/BWPs. Alternatively or additionally, if an indication of at least one available UL carrier/BWP is received in step 1006, then step 1010 may include the processor of the apparatus selecting the first UL carrier/BWP from the at least one available UL carrier/BWP.

The SSB received in step 1002 may be received on an SSB resource from a first network device. In some implementations, the first message transmitted in step 1010 is transmitted to a second network device using the first RACH resource.

Step 1010 may further include a beam sweeping operation. For example, step 1010 may include the transmitter of the apparatus transmitting, on at least some of a plurality of Tx beams corresponding to the plurality of RACH resources, a plurality of messages using the plurality of RACH resources. The plurality of messages includes the first message transmitted on the first Tx beam. For example, the plurality of Tx beams may include the first Tx beam and the first RACH resource used to transmit the first message may correspond to the first Tx beam.

Steps 508, 510 of the process 500 and step 910 of the method 900 provide examples of step 1010.

Optional step 1012 includes the at least one processor of the apparatus determining a first identifier corresponding to the first RACH resource. This first identifier may be an RA-RNTI, for example. The first identifier may be determined based, at least in part, on the first UL carrier/BWP to distinguish the identifier from other RACH resources on other UL carriers/BWPs. For example, identifier may be based on a time resource of the first RACH resource, a frequency resource of the first RACH resource and an index of the first UL carrier/BWP. The index of the first UL carrier/BWP may be received by the apparatus from the network device in step 1002 or in another step, for example. The index of the first UL carrier/BWP may also or instead be determined by the at least one processor of the apparatus based on a predefined rule. Step 514 of the process 500 illustrates an example of step 1012.

In some implementations, when beam sweeping is implemented in step 1010, for example, step 1012 includes determining a plurality of identifiers corresponding to at least some of the plurality of RACH resources. The plurality of identifiers may include the first identifier.

Optional step 1014 includes the receiver of the apparatus receiving a second message. The second message could be received from the same network device that transmitted the SSB and the first information, or another network device. The second message may include an RAR, and may also include DCI that schedules the RAR. In some implementations, step 1014 includes decoding at least a portion of the second message using an identifier determined in step 1012. For example, the CRC of the DCI scheduling the RAR could be descrambled using the identifier.

The second message could be received on a second DL carrier/BWP that may be the same as, or different from, the first DL carrier/BWP. In some implementations, the second DL carrier/BWP corresponds to the first RACH resource used to transmit the first message. The use of the first RACH resource indicates that the apparatus may monitor the second DL carrier/BWP for the second message. In this way, step 1014 includes monitoring the second DL carrier/BWP based on transmitting the first message using the first RACH resource. The first RACH resource may include at least one of a time resource, a frequency resource, a RACH preamble or a RACH format that is indicative of the apparatus monitoring the second DL carrier/BWP for the second message. Step 516 of the process 500 and step 912 of the method 900 provide examples of step 1014.

Optional step 1016 includes the at least one processor of the apparatus determining a preferred Tx beam of a plurality of Tx beams corresponding to the plurality of RACH resources. A preferred Tx beam may be the best Tx beam of the Tx beams used to transmit the plurality of messages. For example, at least a portion of the second message (for example, the CRRC of the DCI scheduling the RAR) is scrambled using a first identifier corresponding to the first RACH resource. The at least one processor of the apparatus may decode the second message using at least some of a plurality of identifiers determined in step 1012, and determine that the second message is successfully decoded using the first identifier. Based on the use of the first identifier to successfully decode the second message, on the correspondence between the first identifier and the first RACH resource, and on the correspondence between the first RACH resource and the first Tx beam, the apparatus may determine that the first Tx beam is the preferred Tx beam of the plurality of Tx beams. Step 914 of the method 900 provides an example of step 1016.

The second message received in step 1014 schedules a third message for the apparatus. Optional step 1018 includes transmitting the third message on a second UL carrier/BWP, which could be a Msg3 transmission. The second UL carrier/BWP may be the same as, or different from, the first UL carrier/BWP. In some implementations, the second message received in step 1014 indicates an index of the second UL carrier/BWP for transmitting the third message. If a preferred Tx beam is determined in step 1016, then the third message may be transmitted using this preferred Tx beam. Step 518 of the process 500 illustrates an example of step 1018.

Optional step 1020 includes the receiver of the apparatus receiving a fourth message, which could be a Msg4 transmission. Step 520 of the process 500 provides an example of step 1020. The DL carrier/BWP that the apparatus monitors for the fourth message could be determined by the at least one processor of the apparatus in any of a number of different ways. In some implementations, the fourth message is received on the second DL carrier/BWP. For example, the apparatus may be configured to receive the fourth message on the same DL carrier/BWP as the second message. In other implementations, the second message indicates a third DL carrier/BWP that may be different from the first DL carrier/BWP and/or from the second DL carrier/BWP, and the fourth message is received on the third DL carrier/BWP.

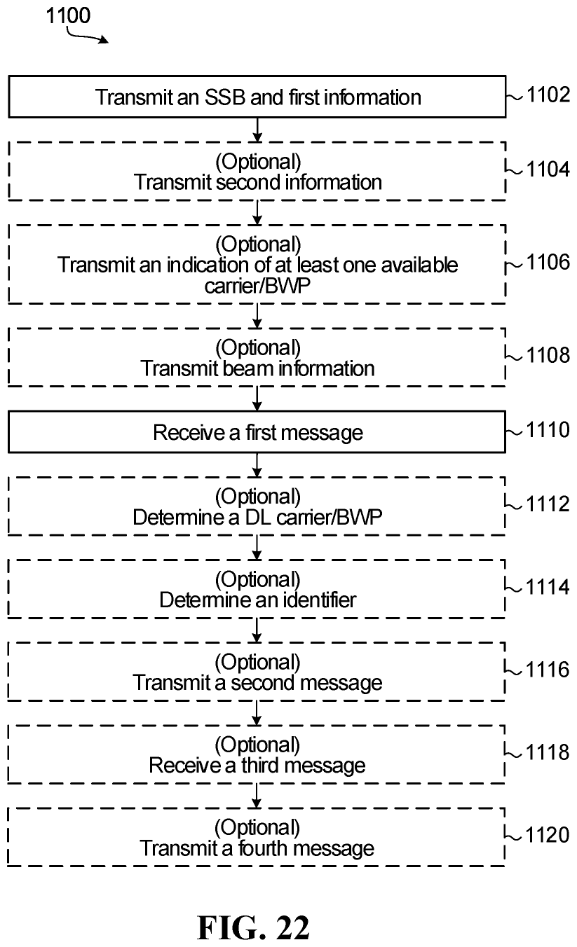

FIG. 22 is a flow diagram illustrating a method 1100 for a wireless communication network, according to an embodiment. The method 1100 will be described as being performed by a system having at least one processor, at least one computer readable storage medium, at least one transmitter and at least one receiver. In some implementations, the at least one computer readable storage medium is operatively coupled to the at least one processor and stores programming for execution by the at least one processor. The programming may include instructions to perform the method 1100. In some implementations, the system includes one or more network devices, such as one or more of the T-TRP 170 and/or the NT-TRP 172 of FIGS. 1 to 3. For example, the at least one processor of the system could include processors in multiple different network devices. In some implementations, the system includes a central computing system that communicates with one or more network devices.

The method 1100 may be considered part of a contention-based initial access process, in which an apparatus establishes communication with the system. An example of the apparatus is the ED 110 of FIGS. 1 to 3. The method 1100 may implement multiple DL carriers/BWPs, multiple UL carriers/BWPs, multiple DL beams and/or multiple UL beams for communication between the system and the apparatus.

Step 1102 includes the at least one transmitter of the system transmitting, on a first DL carrier/BWP, an SSB and first information. The SSB may be transmitted on an SSB resource having a corresponding DL beam, for example. The first information may include system information that indicates a plurality of RACH resources corresponding to a plurality of carriers/BWPs and/or to a plurality of beams. In some implementations, the plurality of RACH resources corresponds to a plurality of uplink carriers/BWPs for random access, a plurality of DL carriers/BWPs for random access, and/or a plurality of Tx beams for random access. Steps 502, 504 of the process 500 of FIG. 10 provide an example of step 1102.

Optional step 1104 includes the at least one transmitter of the system transmitting second information pertaining to the plurality of UL carriers/BWPs. The second information may include at least one of a traffic load, an interference degree, a RACH collision ratio, a successful RACH ratio or a priority indication for at least one of the plurality of UL carriers/BWPs. The second information may be received by the apparatus. Step 506 of the process 500 provides an example of step 1104.

Optional step 1106 includes the at least one transmitter of the system transmitting an indication of at least one available UL carrier/BWP within the plurality of UL carriers/BWPs. The indication of the at least one available UL carrier/BWP may be received by the apparatus.

Optional step 1108 includes the at least one transmitter of the system transmitting beam information for a plurality of Tx beams corresponding to the plurality of RACH resources. In some implementations, the beam information is based on sensing information and/or position information corresponding to the apparatus. For example, the system may have generated the beam information using an AI/ML model, with the sensing information and/or the position information used as inputs to the AI/ML model.

Optional step 1108 may also or instead include the at least one transmitter of the system transmitting an indication to enable transmit beam sweeping at the apparatus. This beam sweeping may include transmitting a plurality of messages using the plurality of RACH resources and at least some of the plurality of Tx beams. Alternatively or additionally, optional step 1108 may include the at least one transmitter of the system transmitting an indication of a trigger condition or another condition for beam sweeping. Alternatively or additionally, optional step 1108 may include the at least one transmitter of the system transmitting an indication of a neighboring network device for the beam sweeping. For example, the SSB may be transmitted by a first network device, and the indication transmitted in step 1008 may indicate a second network device for uplink communication with the apparatus. Alternatively or additionally, step 1008 may include the at least one transmitter of the system transmitting an indication of a maximum number of messages to transmit in a beam sweeping operation. Steps 902, 906, 908, 909 of the method 900 of FIG. 19 provide examples of step 1008.

Step 1110 includes the at least one receiver of the system receiving, from the apparatus on a first UL carrier/BWP, a first message using a first RACH resource of the plurality of RACH resources. The first message may be a PRACH transmission, for example. If the RACH resources correspond to a plurality of UL carriers/BWPs, then the plurality of UL carriers/BWPs may include the first UL carrier/BWP and the first RACH resource may correspond to the first uplink carrier/BWP. In some implementations, the first DL carrier/BWP used to transmit the SSB and first information is in a different frequency band than the first UL carrier/BWP.

The first message may be received on first Tx beam of a plurality of Tx beams corresponding to the plurality of RACH resources. For example, the plurality of Tx beams may include the first Tx beam and the first RACH resource may correspond to the first Tx beam.

In some implementations, the SSB is transmitted from a first network device of the system in step 1102, and the first message may be received at a second network device of the system using the first RACH resource.

Step 510 of the process 500 and step 910 of the method 900 provide examples of step 1010.

If the first UL carrier/BWP includes RACH resources corresponding to multiple different DL carriers/BWPs, then optional step 1112 may be performed to determine which DL carrier/BWP the apparatus received the SSB on. Optional step 1112 includes the at least one processor of the system determining that the apparatus received the SSB on the first UL carrier/BWP based on at least one of a time resource, a frequency resource, a RACH preamble or a RACH format of the first RACH resource. Step 512 of the process 500 provides an example of step 1112.

Optional step 1114 includes the at least one processor of the system determining an identifier, such as an RA-RNTI, based on the first UL carrier/BWP. In some implementations, the identifier is based on a time resource of the first RACH resource, a frequency resource of the first RACH resource and an index of the first UL carrier/BWP. The at least one transmitter of the system might transmit an indication of the index of the first UL carrier/BWP, to allow the apparatus to calculate the identifier. Step 514 of the process 500 illustrates an example of step 1114.

Optional step 1116 includes the at least one transmitter of the system transmitting, to the apparatus on a second DL carrier/BWP, a second message scheduling a third message. The second message could include an RAR, and could also a DCI scheduling the RAR. Step 1116 may also include scrambling at least a portion of the second message using the identifier determined in step 1114. For example, the CRC of the DCI could be scrambled using the identifier. Step 516 of the process 500 and step 912 of the method 900 provide examples of step 1016.

The second DL carrier/BWP could be the same as, or different from, the first DL carrier/BWP. In some implementations, transmitting the second message on the second DL carrier/BWP is based on receiving the first message using the first RACH resource. For example, the first RACH resource may be correspond to the second DL carrier/BWP, such that the use of the first RACH resource for the first message indicates that the apparatus is monitoring the second DL carrier/BWP for the second message. The first RACH resource may include at least one of a time resource, a frequency resource, a RACH preamble or a RACH format that is indicative of the apparatus monitoring the second DL carrier/BWP for the second message.

The second message may indicate an index of the second UL carrier/BWP for transmitting the third message. In some implementations, the second UL carrier/BWP is different from the first UL carrier/BWP. Optional step 1118 includes the at least one receiver of the system receiving, from the apparatus, the third message on the second UL carrier/BWP. The third message could be a Msg3 transmission. The third message may be received on the first Tx beam used to transmit the first message. Step 518 of the process 500 illustrates an example of step 1118.

Optional step 1120 includes the at least one of transmitter of the system transmitting, to the apparatus, a fourth message. The fourth message could be a Msg4 transmission. In some implementations, the fourth message is transmitted on the second DL carrier/BWP. In other implementations, the second message indicates, to the apparatus, a third DL carrier/BWP different from the second downlink carrier/BWP and/or from the first DL carrier/BWP, and the fourth message is transmitted on the third DL carrier/BWP. Step 520 of the process 500 provides an example of step 1120.

It should be noted that the order of the steps in FIGS. 21 and 22 are provided by way of example only. Other orders of these steps, including steps that are performed simultaneously (for example, performing two or more steps in a single transmission or reception), are also contemplated. For example, at least two of steps 1102, 1104, 1106, 1108 may implemented as a single transmission.

### CONCLUSION

Although the present disclosure describes methods and processes with steps in a certain order, one or more steps of the methods and processes may be omitted or altered as appropriate. One or more steps may take place in an order other than that in which they are described, as appropriate.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration information, or other data, which, when executed, cause a machine (e.g., a processor or other processing device) to perform steps in a method according to examples of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A method comprising:
receiving, on a first downlink carrier and/or bandwidth part (carrier/BWP), a synchronization signal block (SSB) and first information, the first information indicating a plurality of random access channel (RACH) resources corresponding to a plurality of carriers/BWPs and/or to a plurality of beams; and
transmitting, on a first uplink carrier/BWP, a first message using a first RACH resource of the plurality of RACH resources.

2. The method of claim 1, wherein the plurality of RACH resources corresponds to a plurality of uplink carriers/BWPs for random access, the plurality of uplink carriers/BWPs comprises the first uplink carrier/BWP, and the first RACH resource corresponds to the first uplink carrier/BWP.

3. The method of claim 1, the method further comprising:
receiving, on a second downlink carrier/BWP, a second message scheduling a third message; and
transmitting the third message on a second uplink carrier/BWP.

4. The method of claim 3, the method further comprising:
determining an identifier based on the first uplink carrier/BWP,
wherein receiving the second message comprises decoding at least a portion of the second message using the identifier.

5. The method of claim 3, wherein the second downlink carrier/BWP is the same as the first downlink carrier/BWP and the second message indicates a third downlink carrier/BWP different from the first downlink carrier/BWP, the method comprising:
receiving a fourth message on the third downlink carrier/BWP.

6. A method comprising:
transmitting, on a first downlink carrier and/or bandwidth part (carrier/BWP), a synchronization signal block (SSB) and first information, the first information indicating a plurality of random access channel (RACH) resources corresponding to a plurality of carriers/BWPs and/or to a plurality of beams; and
receiving, on a first uplink carrier/BWP, a first message using a first RACH resource of the plurality of RACH resources.

7. The method of claim 6, wherein the plurality of RACH resources corresponds to a plurality of uplink carriers/BWPs for random access, the plurality of uplink carriers/BWPs comprises the first uplink carrier/BWP, and the first RACH resource corresponds to the first uplink carrier/BWP.

8. The method of claim 6, the method further comprising:
transmitting, on a second downlink carrier/BWP, a second message scheduling a third message; and
receiving the third message on a second uplink carrier/BWP.

9. The method of claim 8, the method comprising:
determining an identifier based on the first uplink carrier/BWP,
wherein transmitting the second message comprises scrambling at least a portion of the second message using the identifier.

10. The method of claim 8, wherein the second downlink carrier/BWP is the same as the first downlink carrier/BWP and the second message indicates a third downlink carrier/BWP different from the first downlink carrier/BWP, the method comprising:
transmitting a fourth message on the third downlink carrier/BWP.

11. An apparatus comprising:
at least one processor; and
a non-transitory computer readable storage medium storing programming for execution by the at least one processor, the programming comprising instructions to cause the apparatus to:
receive, on a first downlink carrier and/or bandwidth part (carrier/BWP), a synchronization signal block (SSB) and first information, the first information indicating a plurality of random access channel (RACH) resources corresponding to a plurality of carriers/BWPs and/or to a plurality of beams; and
transmit, on a first uplink carrier/BWP, a first message using a first RACH resource of the plurality of RACH resources.

12. The apparatus of claim 11, wherein the plurality of RACH resources corresponds to a plurality of uplink carriers/BWPs for random access, the plurality of uplink carriers/BWPs comprises the first uplink carrier/BWP, and the first RACH resource corresponds to the first uplink carrier/BWP.

13. The apparatus of claim 11, wherein the programming further comprises instructions to cause the apparatus to:
receive, on a second downlink carrier/BWP, a second message scheduling a third message; and
transmit the third message on a second uplink carrier/BWP.

14. The apparatus of claim 13, wherein the programming further comprises instructions to cause the apparatus to:
determine an identifier based on the first uplink carrier/BWP; and
decode at least a portion of the second message using the identifier.

15. The apparatus of claim 13, wherein:
the second downlink carrier/BWP is the same as the first downlink carrier/BWP and the second message indicates a third downlink carrier/BWP different from the first downlink carrier/BWP; and
the programming further comprises instructions to cause the apparatus to receive a fourth message on the third downlink carrier/BWP.

16. An apparatus comprising:
at least one processor; and
a non-transitory computer readable storage medium storing programming for execution by the at least one processor, the programming comprising instructions to cause the apparatus to:
transmit, on a first downlink carrier and/or bandwidth part (carrier/BWP), a synchronization signal block (SSB) and first information, the first information indicating a plurality of random access channel (RACH) resources corresponding to a plurality of carriers/BWPs and/or to a plurality of beams; and
receive, on a first uplink carrier/BWP, a first message using a first RACH resource of the plurality of RACH resources.

17. The apparatus of claim 16, wherein the plurality of RACH resources corresponds to a plurality of uplink carriers/BWPs for random access, the plurality of uplink carriers/BWPs comprises the first uplink carrier/BWP, and the first RACH resource corresponds to the first uplink carrier/BWP.

18. The apparatus of claim 16, wherein the programming further comprises instructions to cause the apparatus to:
transmit, on a second downlink carrier/BWP, a second message scheduling a third message; and
receive the third message on a second uplink carrier/BWP.

19. The apparatus of claim 18, wherein the programming further comprises instructions to cause the apparatus to:
determine an identifier based on the first uplink carrier/BWP; and
scramble at least a portion of the second message using the identifier.

20. The apparatus of claim 18, wherein:
the second downlink carrier/BWP is the same as the first downlink carrier/BWP and the second message indicates a third downlink carrier/BWP different from the first downlink carrier/BWP; and
the programming further comprises instructions to cause the apparatus to transmit a fourth message on the third downlink carrier/BWP.
